(19) United States
(12) Patent Application Publication
(10) Pub. No.: US 2009/0099875 A1
(43) Pub. Date: Apr. 16, 2009

(54) Expert system and method for translating, evaluating, monitoring, assessing, auditing, profiling, compiling and quantifying medical data sets

(76) Inventor: Allen Roy Koenig, Honolulu, HI (US)

Correspondence Address: ROBERT M. HUNTER PLLC, P.O. BOX 2709, KAMUELA, HI, 96743, US

(21) Appl. No.: 12/287,553

(22) Filed: Oct. 11, 2008

Related U.S. Application Data
(63) Continuation-in-part of application No. PCT/US07/09086, filed on Apr. 12, 2007.
(60) Provisional application No. 60/792,115, filed on Apr. 13, 2006.

(51) Int. Cl. G06Q 50/00; G06T 11/20; G06Q 40/00; G06F 17/30; G06F 7/06

(52) U.S. Cl. 705/3; 705/2; 345/440.2; 705/4; 707/103 Y; 707/3; 707/E17.005; 707/E17.011; 707/E17.014

(57) ABSTRACT

A computer-implemented system and method for evaluating a soft-tissue injury claim, said method comprising: inputting a claimant; creating a claim and associating it with said claimant and with an injury site; associating a first visit with said claim; selecting a standard; inputting a first measurement characterizing said injury site from said first visit; associating a second visit with said claim; inputting a second measurement characterizing said injury site from said second visit; calculating a percent deficit for each measurement by comparing each measurement to said standard, and a percent improvement by comparing said first measurement taken on a first visit to said second measurement taken on said second visit to produce a plurality of calculated findings; and generating a report that presents each of said measurements and each of said calculated findings in a graphical format and/or a tabular format.

### CROSS-REFERENCE TO RELATED APPLICATIONS

This application is a continuation-in-part of International Patent Application No. PCT/US 2007/09086, filed on Apr. 12, 2007, which claimed the benefit of U.S. Provisional Patent Application No. 60/792,115, filed Apr. 13, 2006, the disclosures of which patent applications are incorporated by reference as if fully set forth herein.

A portion of the disclosure of this patent document contains material which is subject to copyright protection. The copyright owner has no objection to the facsimile reproduction by anyone of the patent document or the patent disclosure as it appears in the Patent and Trademark Office patent files or records, but otherwise reserves all copyrights whatsoever.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

This invention relates to medical information technology. In particular, the invention relates to a computer-implemented expert system and method for translating, evaluating, monitoring, assessing, auditing, profiling, compiling, and quantifying objective written multiple medical data sets into graphic reports. In this disclosure, the term “objective findings” means the results of the actual range of motion measurements of a joint motion in degrees reported by a medical provider that characterize soft-tissue injuries or the results of calculations based on such measurements. Thus, “objective findings” are not subjective in nature.

Medical care providers treating soft-tissue injuries are usually required to provide objective findings (measurements) that characterize the injury in order to be paid by third party insurance carriers. Each measurement is representative of the following: an injury site (e.g., cervical), an affected motion (e.g., flexion), and an integer representing a degree of range of motion compared to an acceptable referenced reportable standard (e.g., 30 degrees). The acceptable referenced reportable standard may be either the American Medical Association (AMA) Standard or the American Academy of Orthopedic Surgeons (AAOS) Standard. The measurements are usually reported and documented in the medical records of the injured person at each medical visit in a data record that includes a description of the injury site, a description of the motion, and an integer. The data record may include an applicable location of the injury site, e.g., left shoulder.

With just one finding in each data record, a person without medical training may not be able to easily and quickly interpret the findings to determine a deficit from the standard without performing multiple complex calculations and referring to a table of reference standards. A person with medical training would also have a difficult time determining a deficit from the standard without performing multiple complex calculations and referring to a table of reference standards.

With a chronological series of findings in a medical record, a person without medical training would find it difficult to quickly and easily interpret the findings to determine a deficit from the standard and to determine if the injury is getting better, getting worse or stabilized without performing multiple complex calculations and referring to a table of reference standards. A person with medical training would have a difficult time determining a deficit from the standard without performing multiple complex calculations and referring to a table of reference standards but would not have a difficult time quickly and easily interpreting the findings to determine if the injury is getting better, getting worse or has stabilized.

In the background art, insurance claims adjusters, insurance defense attorneys and personal injury attorneys often rely on the “subjective” (spoken or written) findings of medical providers to determine the effective utilization of services because they do not understand the “objective” (based on actual measurements) findings of a soft-tissue injury. Problems arise whenever there is a dispute between the interpretations of the findings. Typically, each party to the dispute hires a medical service provider to prepare an independent medical evaluation report containing his or her subjective version of the findings. It is quite common for the same injury and treatment outcomes to have different subjective findings, depending on who is providing the report for whom.

What is needed is a system and method for presenting the actual measurements of the soft-tissue injury in a simple form that eliminates the need for subjective findings and presents the objective findings in a format that is easy to read and evaluate. The parties to the dispute cannot refute the objective findings because they are the objective findings of the treating provider, presented in an understandable format.

The background art is characterized by U.S. Pat. Nos. 4,922,925; 5,078,152; 5,253,164; 5,313,968; 5,325,293; 5,373,858; 5,410,472; 5,524,645; 5,557,514; 5,810,747; 5,830,160; 5,835,897; 5,842,175; 5,845,254; 5,956,687; 5,970,463; 6,177,940; 6,324,516; 6,436,058; and 6,821,257; and U.S. Patent Application Nos. 2002/0069089; 2003/0078816; 2003/0200121; 2003/0200123; 2004/0220490; 2004/0249675; 2005/0027567; 2005/0060192; 2005/0108067; 2005/0210044; 2005/0223799; 2005/0246206; and 2005/0256744; the disclosures of which patents and patent applications are incorporated by reference as if fully set forth herein.

Wills in U.S. Pat. No. 5,524,645 discloses a measurement tool for evaluating medical therapy outcomes in accordance with quantified physical therapy data. This invention is limited because calculation of a physical therapy index is required (see his FIG. 6). Tracking of a subjectively-defined combined index can mask individual data values that are significant indicators of injury status. Moreover, comparison of objective data to an accepted standard is not performed. The Wills reference teaches that “sets of parameters associated with respective body regions” (his col. 2, lines 59-60) must be evaluated and re-evaluated “over time” (his col. 6, line 55) rather than recording actual “measurements” that are integral to the effectiveness of the applicant's invention. The Wills reference is limited in that it teaches assigning a “numerical data value” to each “parameter code” in a way that is not objective: “in the illustrated examples of FIG. 5, for the parameter: gait, a maximum data value of 6 may be associated with full movement within normal limits (WNL), a protected, guarded or antalgic movement may be assigned a value of 4, the use of an assistive device (crutch) may be assigned a value of 2, and minimal value (e.g. zero) may be associated with a pathological condition in which movement is not possible. Similarly, for gross active range of motion, a maximum data value of 12 may be associated with full movement within its normal limits, a lesser range of values 0-10 may be associated with limited painful movement” (his col. 5, lines 49-60). Thus, assignment of numerical data values to individual parameters in accordance with the Wills invention is not objective and therefore his numerical data values are not “objective findings.”

Furthermore, the Wills reference teaches that “once all of the parameters of a given body region have been assigned a numerical value, the values are combined, for example, summed, to thereby quantify the overall condition or dysfunction of the body region” (his col. 3, lines 16-20). Because “the upper limit may vary among different parameters” (his col. 5, lines 65-66), combining or summing the subjective parameter scores to produce a “total score for each respective body region” (his col. 6, lines 12-13) further separates the evaluation from the objective reality that is the hallmark of the applicant's invention.

Andros et al. in U.S. Pat. No. 5,842,175 disclose a computer system for assisting in the administration and monitoring of patient therapy. This invention is limited in that only initial, today and goal objective findings are displayed and only in a tabular format (see their FIGS. 18 and 30). This approach does not allow the user to track specific objective findings over time in a graphical format. Moreover, comparison of objective data to an accepted standard is not performed and a percent deficit is not calculated and displayed.

Burge et al. in U.S. Patent Application No. 2003/0200123 discloses an injury analysis system and method for insurance claims. The Burge et al. reference is limited in that it teaches that “soft-tissue injuries are muscle sprains and strains that cannot be objectively verified by medical evidence” (para. 0002). The Burge et al. reference also teaches that “because there is no objective evidence that these injuries exist, claims adjusters must look at evidence regarding the injury potential of the accident and make judgments about whether the forces were sufficient to cause the claimed injuries.”

Stark et al. in U.S. Patent Application No. 2004/0249675 discloses a system for medical protocol management. This invention is limited in that raw objective data are compared to a subjective goal (see their FIGS. 12A-12D) in a graphical format and to the statistical, historical performance of other patients who are subjectively determined to have the same (or nearly the same) injury and demographic background. Moreover, comparison of objective data to an accepted standard is not performed, and a percent deficit is not calculated and displayed.

### BRIEF SUMMARY OF THE INVENTION

One purpose of preferred embodiments of the invention is to allow a non-medically trained person to easily and quickly assess the percentage of deficit from a medical standard of a soft-tissue injury and the percentage of improvement from a medical standard of a soft-tissue injury. Another purpose of preferred embodiments of the invention is to allow a non-medically trained person to easily and quickly identify the cumulative effects of medical treatments of soft-tissue injuries to determine if the injured person is getting better, getting worse, stabilized or displaying fraudulent behaviors. Another purpose of preferred embodiments of the invention is to quickly and easily provide a range of value for general damages for settlement for soft-tissue personal injury litigation. Another purpose of preferred embodiments of the invention is to quickly and easily provide a range of values for settlement of workman's compensation soft-tissue injury cases.

With preferred embodiments of the invention, objective medical data characterizing soft-tissue injuries are reported in a format that is familiar to medically-trained personnel. In accordance with the invention, converting the cumulative objective data into a form that demonstrates a percentage of improvement or deficit from the original injury, in a format that is easy to read, allows non-medically-trained users of the information to make quick and accurate assessment of the nature of recovery from the injury to easily determine if the injury is getting better, worse, or staying the same.

The invention is useful in a variety of ways. Insurance claims adjusters can use the invention to efficiently manage the utilization of medical services and easily identify action points that allow them to monitor and manage soft-tissue injury claims. Personal injury attorneys and insurance defense attorneys can use the reports produced by the invention to quickly determine the claim value of soft-tissue injury cases.

In a preferred embodiment, the invention is a computer-implemented method for evaluating a soft-tissue injury claim, said method comprising: creating a claimant record; creating a claim record and associating it with said claimant record, said claim record being further associated with at least one injury site record and optionally being further associated with a carrier record, a provider record, an attorney record, an adjuster record, a private investigator record and a reviewer record; inputting an injury site to said at least one injury site record; associating a first visit record with said claim record; selecting a standard and creating a first objective findings record that is associated with said first visit record and said at least one injury site record; inputting a first measurement characterizing said injury site from said first visit into said first objective findings record; associating a second visit record with said claim record; creating a second objective findings record that is associated with said second visit record and said injury site record; inputting a second measurement characterizing said injury site from said second visit into said second objective findings record; calculating a percent deficit for each measurement by comparing each measurement to said standard, and a percent improvement by comparing said first measurement taken on a first visit to said second measurement taken on said second visit to produce a plurality of calculated objective findings; and generating a report that presents each of said measurements and each of said calculated objective findings in a graphical format and/or a tabular format. Preferably, said claim record is further associated with a non-injured side record and the method further comprises: selecting a standard and creating a third objective findings record that is associated with said first visit record and said non-injured side record; inputting a first non-injured side measurement characterizing said non-injured side from said first visit into said third objective findings record; creating a fourth objective findings record that is associated with said second visit record and said non-injured side record; inputting a second non-injured side measurement characterizing said non-injured side from said second visit into said fourth objective findings record; calculating a non-injured percent deficit for each non-injured side measurement by comparing each non-injured side measurement to said standard, and a percent improvement by comparing said first non-injured side measurement taken on a first visit to said second non-injured side measurement taken on said second visit to produce a second plurality of calculated objective findings.

In another preferred embodiment, the invention is a computer-implemented method for evaluating a soft-tissue injury claim, said method comprising: inputting a claimant; creating a claim and associating it with said claimant and with an injury site; associating a first visit with said claim; selecting a standard; inputting a first measurement characterizing said injury site from said first visit; associating a second visit with said claim; inputting a second measurement characterizing said injury site from said second visit; calculating a percent deficit for each measurement by comparing each measurement to said standard, and a percent improvement by comparing said first measurement taken on a first visit to said second measurement taken on said second visit to produce a plurality of calculated findings; and generating a report that presents each of said measurements and each of said calculated findings in a graphical format and/or a tabular format. Preferably, claim is further associated with a non-injured side and the method further comprises: inputting a first non-injured side measurement characterizing said non-injured side from said first visit; inputting a second non-injured side measurement characterizing said non-injured side from said second visit; calculating a non-injured percent deficit for each non-injured side measurement by comparing each non-injured side measurement to said standard, and a percent improvement by comparing said first non-injured side measurement taken on a first visit to said second non-injured side measurement taken on said second visit to produce a second plurality of calculated findings.

In yet another preferred embodiment, the invention is a computer-implemented method for evaluating a soft-tissue injury claim, said method comprising: a step for creating a claimant record; a step for creating a claim record and associating it with said claimant record, said claim record being associated with an injury site record; a step for inputting an injury site to said injury site record; a step for associating a first visit record with said claim record; a step for selecting a standard and creating a first objective findings record that is associated with said first visit record and said injury site record; a step for inputting a first measurement characterizing said injury site from said first visit into said first objective findings record; a step for associating a second visit record with said claim record; a step for creating a second objective findings record that is associated with said second visit record and said injury site record; a step for inputting a second measurement characterizing said injury site from said second visit into said second objective findings record; a step for calculating a percent deficit for each measurement by comparing each measurement to said standard, and a percent improvement by comparing said first measurement taken on a first visit to said second measurement taken on said second visit to produce a plurality of calculated objective findings; and a step for generating a report that presents each of said measurements and each of said calculated objective findings. Preferably, said report comprises a bar graph having a bar that represents each measurement.

In a further preferred embodiment, the invention is a computer-implemented method for evaluating a condition, said method comprising: selecting a protocol that characterizes a severity of the condition, and identifying a standard result of performing said protocol on a patient that does not have the condition; inputting a plurality of visit records, each visit record comprising a visit date, and a measurement of said severity obtained by having said patient perform said protocol; calculating a percent deficit by comparing said measurement to said standard result, and a percent improvement by comparing one measurement taken on a first visit date to another measurement taken on a subsequent visit date to produce a plurality of objective findings; and generating a report that presents each of said objective findings. Preferably, said report presents said one measurement and said another measurement in a time sequence. Preferably, the method further comprises: adding a finding and/or a recommendation to said report.

In another preferred embodiment, the invention is a computer-implemented system for evaluating a soft-tissue injury claim, said system comprising: means for creating a claimant record; means for creating a claim record and associating it with said claimant record, said claim record being associated with at least one injury site record and optionally being associated with a carrier record, a provider record, an attorney record, an adjuster record, a private investigator record and a reviewer record; means for inputting an injury site to said at least one injury site record; means for associating a first visit record with said claim record; means for selecting a standard and creating a first objective findings record that is associated with said first visit record and said at least one injury site record; means for inputting a first measurement characterizing said injury site from said first visit into said first objective findings record; means for associating a second visit record with said claim record; means for creating a second objective findings record that is associated with said second visit record and said injury site record; means for inputting a second measurement characterizing said injury site from said second visit into said second objective findings record; means for calculating a percent deficit for each measurement by comparing each measurement to said standard, and a percent improvement by comparing said first measurement taken on a first visit to said second measurement taken on said second visit to produce a plurality of calculated objective findings; and means for generating a report that presents each of said measurements and each of said calculated objective findings in a graphical format and/or a tabular format. Preferably, said claim record is further associated with a non-injured side record and the system further comprises: means for selecting a standard and creating a third objective findings record that is associated with said first visit record and said non-injured side record; means for inputting a first non-injured side measurement characterizing said non-injured side from said first visit into said third objective findings record; means for creating a fourth objective findings record that is associated with said second visit record and said non-injured side record; means for inputting a second non-injured side measurement characterizing said non-injured side from said second visit into said fourth objective findings record; means for calculating a non-injured percent deficit for each non-injured side measurement by comparing each non-injured side measurement to said standard, and a percent improvement by comparing said first non-injured side measurement taken on a first visit to said second non-injured side measurement taken on said second visit to produce a second plurality of calculated objective findings.

In another preferred embodiment, the invention is a computer-implemented system for evaluating a soft-tissue injury claim, said system comprising: means for inputting a claimant; means for creating a claim and associating it with said claimant and with an injury site; means for associating a first visit with said claim; means for selecting a standard; means for inputting a first measurement characterizing said injury site from said first visit; means for associating a second visit with said claim; means for inputting a second measurement characterizing said injury site from said second visit; means for calculating a percent deficit for each measurement by comparing each measurement to said standard, and a percent improvement by comparing said first measurement taken on a first visit to said second measurement taken on said second visit to produce a plurality of calculated findings; and means for generating a report that presents each of said measurements and each of said calculated findings in a graphical format and/or a tabular format. Preferably, said claim is further associated with a non-injured side and the system further comprises: means for inputting a first non-injured side measurement characterizing said non-injured side from said first visit; means for inputting a second non-injured side measurement characterizing said non-injured side from said second visit; means for calculating a non-injured percent deficit for each non-injured side measurement by comparing each non-injured side measurement to said standard, and a percent improvement by comparing said first non-injured side measurement taken on a first visit to said second non-injured side measurement taken on said second visit to produce a second plurality of calculated findings.

In yet another preferred embodiment, the invention is a computer-implemented system for evaluating a soft-tissue injury claim, said system comprising: means for creating a claimant record; means for creating a claim record and associating it with said claimant record, said claim record being associated with an injury site record; means for inputting an injury site to said injury site record; means for associating a first visit record with said claim record; means for selecting a standard and creating a first objective findings record that is associated with said first visit record and said injury site record; means for inputting a first measurement characterizing said injury site from said first visit into said first objective findings record; means for associating a second visit record with said claim record; means for creating a second objective findings record that is associated with said second visit record and said injury site record; means for inputting a second measurement characterizing said injury site from said second visit into said second objective findings record; means for calculating a percent deficit for each measurement by comparing each measurement to said standard, and a percent improvement by comparing said first measurement taken on a first visit to said second measurement taken on said second visit to produce a plurality of calculated objective findings; and means for generating a report that presents each of said measurements and each of said calculated objective findings. Preferably, said report comprises a bar graph having a bar that represents each measurement.

In a further preferred embodiment, the invention is a computer-implemented system for evaluating a condition, said system comprising: means for selecting a protocol that characterizes a severity of the condition, and identifying a standard result of performing said protocol on a patient that does not have said condition; means for inputting a plurality of visit records, each visit record comprising a visit date, and a measurement of said severity obtained by having said patient perform said protocol; means for calculating a percent deficit by comparing said measurement to said standard result, and a percent improvement by comparing one measurement taken on a first visit date to another measurement taken on a subsequent visit date to produce a plurality of objective findings; and means for generating a report that presents each of said objective findings. Preferably, the system further comprises: means for adding a finding and/or a recommendation to said report.

In another preferred embodiment, the invention is a computer-implemented system for evaluating a condition having a severity, said system comprising: a computer having a memory and a monitor, said memory hosting a database; said database having at least one claim record that is associated with a claimant record; each claim record having an injury site record and a visit record, and optionally a report history record, a saved reports record, a carrier record, a provider record, an attorney record, an adjuster record, a private investigator record and/or a reviewer record; each visit record having a date of examination field and being associated with at least one objective finding record, each objective finding record containing an objective finding comprising a range of motion measurement that characterizes the severity of the condition; said monitor being operative to display a report for each injury site, said report containing a tabular or bar graph representation of each objective finding on each examination date and a comparison of each objective finding to a standard over time, said comparison comprising a percent improvement from a baseline objective finding and a percent deficit from said standard.

In another preferred embodiment, the invention is a computer-readable medium having computer-executable instructions for performing a method for evaluating the effects of treatment of an injury, the method comprising: selecting a protocol that characterizes a severity of the injury, and identifying a standard result of performing said protocol on a patient that does not have the injury; inputting a plurality of visit records, each visit record comprising a visit date, and a measurement of said severity obtained by having said patient perform said protocol; calculating a percent deficit by comparing said measurement to said standard result, and a percent improvement by comparing one measurement taken on a first visit date to another measurement taken on a subsequent visit date to produce a plurality of objective findings; and generating a report that presents all of said objective findings.

In another preferred embodiment, the invention is a computer-readable medium having computer-executable instructions for performing a method for evaluating the effects of treatment, the method comprising: performing the steps of a method disclosed herein. In another preferred embodiment, the invention is a computer-implemented method for evaluating an injury to a claimant, said method comprising: selecting a claim from a claim grid, said claim having a date that the injury occurred, a protocol that characterizes a severity of the injury, and having a standard result of performing said protocol on a patient that does not have the injury; inputting a plurality of visit records, each visit record comprising a visit date, and a measurement of said severity obtained by having said claimant perform said protocol; calculating a percent deficit by comparing said measurement to said standard result, and a percent improvement by comparing one measurement taken on a first visit date to another measurement taken on a subsequent visit date to produce a plurality of objective findings; and generating a report that presents a selected number of said objective findings. Preferably, said report being selected from the group consisting of an initial report, a follow-up report, an injury history report, and a special comprehensive report. Preferably, said initial report comprises: (1) a name and address of carrier and adjuster, (2) a report date, (3) a reviewer name and contact information, (4) a summary of information about said claim and the claimant, (5) a reviewer's findings, recommendations and additional information, (6) a summary of the initial findings measurements, (7) a summary of recent findings measurements, (8) a summary of the claimant's history of visits, (9) a history of special evaluations, hospitalizations, and special diagnostic procedures and (10) a history of private investigation reports. Preferably, said follow-up report comprises: (1) a name and address of a carrier and an adjuster, (2) a report date, (3) a reviewer name and contact information, (4) a summary of information about said claim and the claimant, (5) a reviewer's findings and recommendations, (6) a summary of recent findings measurements, (7) a summary of the claimant's history of visits since a previous report was generated, (9) a history of special evaluations, hospitalizations, and special diagnostic procedures since said last report was generated and (10) a history of private investigation reports since said last report was generated. Preferably, said injury history report comprises: (1) a name and address of a carrier and an adjuster, (2) a report date, (3) a reviewer name and contact information, (4) a summary of information about said claim and the claimant, (5) reviewer's findings and recommendations and (6) a summary of injuries information from any past claims or as reported in a history of previous injuries record associated with the claimant. Preferably, said special comprehensive report includes: (1) a name and address of a carrier and an adjuster, (2) report date, (3) a reviewer name and contact information, (4) a summary of information about said claim and the claimant, (5) a reviewer's findings and recommendations, (6) a summary of recent findings measurements, (7) a summary of said claimant's history of visits, (8) a history of special evaluations, hospitalizations, and special diagnostic procedures, (9) a list of any additional injuries identified after an initial visit, (10) a history of previous injuries and previous claims, (11) a history of private investigation reports, (12) a list of accident facts entered into injury site records, (13) a list of any treatment notes from providers that were entered into visit records. Preferably, said inputting step is carried out using a personal digital assistant.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the concept. Thus, the following drawings and description are to be regarded as illustrative in nature and not restrictive.

### BRIEF DESCRIPTION OF THE SEVERAL VIEWS OF THE DRAWINGS

The features of the invention will be better understood by reference to the accompanying drawings, which illustrate presently preferred embodiments of the invention. In the drawings:

FIG. 1A is a schematic block diagram of a system that implements a preferred embodiment of the invention.

FIG. 1B is a schematic entity relationship diagram for a preferred embodiment of the invention.

FIG. 2 is a schematic block diagram of a claim creation operation of a preferred embodiment of the invention.

FIG. 3 is a representation of a screen shot showing a typical Edit Claim window and its display of associated records in accordance with a preferred embodiment of the invention.

FIG. 4 is a representation of a screen shot showing a typical Claim List (Grid) window and its display of selected records in accordance with a preferred embodiment of the invention.

FIG. 5 is a representation of a partial screen shot showing the options drop-down menu of a typical Claim Grid window in accordance with a preferred embodiment of the invention.

FIG. 6 is a representation of a screen shot showing a step (report definition and review) implemented by the Report Wizard of the window in accordance with a preferred embodiment of the invention.

FIG. 7 is a schematic block diagram of a report specification operation of a preferred embodiment of the invention.

FIG. 8 is a schematic block diagram of a create new objective findings records operation of a preferred embodiment of the invention.

FIG. 9 is a schematic block diagram of a duplicate objective findings operation of a preferred embodiment of the invention.

FIG. 10 is a representation of a screen shot showing a typical Edit Visit window and its display of associated records in accordance with a preferred embodiment of the invention.

FIG. 11 is a representation of a screen shot showing a typical Enter Additional Objective Finding window in accordance with a preferred embodiment of the invention.

FIG. 12 is a schematic block diagram of a create non-default objective findings operation of a preferred embodiment of the invention.

FIG. 13 is a representation of a screen shot showing a typical Visit List window in accordance with a preferred embodiment of the invention.

FIG. 14 is a representation of a screen shot showing a typical New Visit window in accordance with a preferred embodiment of the invention.

FIG. 15 is a representation of a partial screen shot showing a standard selection drop down menu of a typical New Visit window in accordance with a preferred embodiment of the invention.

FIG. 16 is a schematic block diagram of a check for motions operation of a preferred embodiment of the invention.

FIG. 17 is a representation of a screen shot showing a typical Edit Visit window presenting calculated findings in accordance with a preferred embodiment of the invention.

FIG. 18 is a representation of a screen shot showing a Build Report Java® server page in accordance with a preferred embodiment of the invention.

FIG. 19 is a representation of a screen shot showing a Preview Report Java® server page in accordance with a preferred embodiment of the invention.

FIG. 20 is an example of a graphic report in accordance with a preferred embodiment of the invention.

FIG. 21 is an example of the first page of an initial report in accordance with a preferred embodiment of the invention.

FIG. 22 is an example of the second page of an initial report in accordance with a preferred embodiment of the invention.

The following reference numerals are used to indicate the parts and environment of the invention on the drawings:
10 system
12 first computer
13 removable media drive
14 keyboard
15 printer
16 monitor, display
17 removable media
18 processor
19 random access memory, memory
20 create claim record step
21 network
22 associate claimant step
23 second computer
24 add injury site step
25 third computer
26 add additional information step
28 add visit records step
30 input objective findings step
32 generate reports step
34 save reports step
40 preview graphs
42 select report type step
44 select template step
46 edit findings and recommendations step
48 select signature step
50 add extra verbiage step
52 build report step
54 display report step

### DETAILED DESCRIPTION OF THE INVENTION

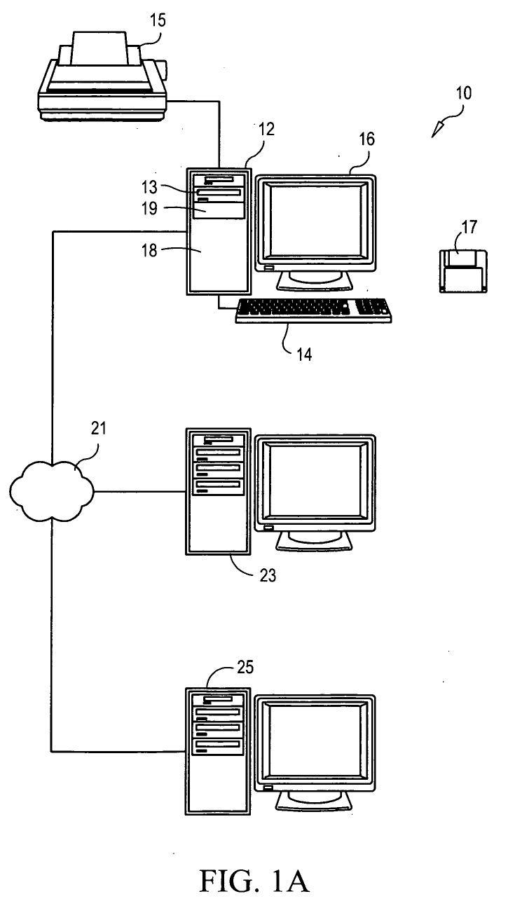

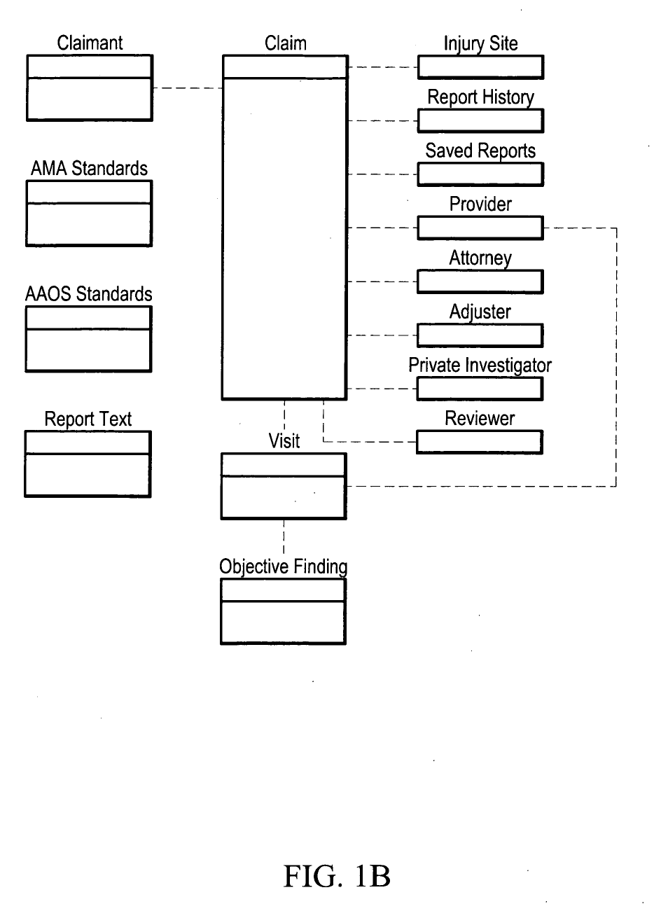

Referring to FIG. 1A, a preferred embodiment of system 10 is illustrated. In this embodiment, system 10 comprises first computer 12, removable media drive 13, keyboard 14, printer 15, monitor or display 16, removable media 17, processor 18 and memory 19. In this embodiment, a software application (not shown) runs on processor 18. System 10 may also include network 21, second computer 23 and third computer 25 and the results produced by system 10 may be communicated via network 21 to second computer 23 and/or third computer 25.

Referring to FIG. 1B a schematic entity relationship diagram is presented for the data structure of the software application in a preferred embodiment of the invention. This embodiment of the system 10 revolves around individual claim files. The model shown in FIG. 1 depicts the main entities and relationships in the operating instructions (software application) for implementing system 10.

Each of the entities in a preferred embodiment of the invention is presented in Table 1. In Table 1, the word “must” in the table below indicates associations that are preferably required upon initial creation of a given type of record. The word “may” indicates associations to other records that may be made after saving a newly created record.

TABLE 1
Entities and Associations

| Record | Associations to other entities | Comments |
|---|---|---|
| Claim | Must be associated to one Claimant | |
| | Must be associated to a specific date of loss | |
| | May be associated to one or more Visit records | |
| | May be associated to one or more Injury Site | |
| | records | |
| | May be associated to one or more Carrier | Only one may be the |
| | records | current Carrier at any |
| | | given time |
| | May be associated to one or more Attorney | |
| | records | |
| | May be associated to one or more Primary | Only one may be the |
| | Provider records | current Primary Provider |
| | | at any given time |
| | May be associated to one or more Secondary | |
| | Provider records | |
| | May be associated to one or more Adjuster | Only one may be the |
| | records | current Adjuster at any |
| | | given time |
| | May be associated to one or more PI | PI means “Private |
| | Assignment records | Investigator” |
| | May be associated to one or more Reviewer | Only one may be the |
| | records | current Reviewer at any |
| | | given time |
| | May be associated to one or more Saved | |
| | Reports records | |
| | May be associated to one or more Report | |
| | History records | |
| AAOS | No entity associations | The AMA Standards and |
| Standards | | AAOS Standards |
| | | entities store data about |
| | | the standard range of |
| | | motion measurements |
| | | used to evaluate |
| | | different injuries. A |
| | | Standards record |
| | | consists of an Injury |
| | | (e.g. “Cervical”), a |
| | | Motion (“Cervical |
| | | Flexion”), a Standard |
| | | ROM measurement |
| | | (“45”), and Unit |
| | | (“degrees”). |
| | | This data is referenced |
| | | by Objective Findings |
| | | records and Reports. |
| | | The Standards records |
| | | also allow storage of an |
| | | image file, which is |
| | | displayed on the Report |
| | | graph associated with |
| | | the injury. |
| AMA | No entity associations | Data is referenced by |
| Standards | | Objective Findings |
| | | records and Reports |
| Adjuster | May be associated to one or more Adjuster | Stores an Adjuster's |
| Contact | records | contact information, |
| Information | | including name and |
| | | address, and the dates |
| | | the adjuster worked on |
| | | the Claim |
| Adjuster | May be associated to one or more Claim | |
| | records | |
| | Must be associated to one Adjuster Contact | |
| | Information record | |
| Attorney | May be associated to one or more Attorney | Stores an Attorney's |
| Contact | records | contact information and |
| Information | | the dates the attorney |
| | | worked on the Claim |
| Attorney | May be associated to one or more Claim | |
| | records | |
| | Must be associated to one Attorney Contact | |
| | Information record | |
| Carrier | May be associated to one or more Carrier | Stores a Carrier's |
| Contact | records | contact information and |
| Information | | the dates the carrier was |
| | | associated to the Claim |
| Carrier | May be associated to one or more Claim | |
| | records | |
| | Must be associated to one Carrier Contact | |
| | Information record | |
| Claimant | May be associated to one or more Claims | |
| | records | |
| | May be associated to one or more History of | |
| | Previous Injuries records | |
| | May be associated to one or more Employer | Only one may be the |
| | records | current Employer at any |
| | | given time |
| Employer | May be associated to one or more Claimant | Only one may be the |
| | records | current Employer at any |
| | | given time |
| History of | Must be associated to one Claimant record | |
| Previous | | |
| Injuries | | |
| Hospitalization | Must be associated to one or more Visit records | |
| Injury Site | May be associated to only one Claim record | |
| Obj Finding | Must be associated to one Visit record | Obj means “Objective” |
| PI | May be associated to one or more Claim | PI means “Private |
| | records | Investigator” |
| | May be associated to one or more PI | |
| | Assignment records | |
| PI Assignment | Must be associated to one PI record | |
| | May be associated to one or more Surveillance | |
| | History records | |
| | May be associated to one Claim record | |
| Primary | Must be associated to one Provider record | |
| Provider | May be associated to one or more Claim | |
| | records | |
| Provider | May be associated to one or more Primary | Provider records store |
| Contact | Provider records | reusable contact |
| Information | May be associated to one or more Secondary | information to be |
| | Provider records | associated with different |
| | May be associated to one or more Special | Claims through these |
| | Evaluations records | three types of records |
| Report History | May be associated to one Claim record | |
| Report Text | No record associations | Report Text records are |
| | | referenced by the Report |
| | | generation engine |
| Reviewer | May be associated to one or more Reviewer | |
| Contact | records | |
| Information | | |
| Reviewer | Must be associated to one Claim record | Stores a Reviewer's |
| | Must be associated to one Reviewer Contact | contact information and |
| | Information record | the dates that the |
| | | reviewer worked on the |
| | | Claim |
| Saved Reports | Must be associated to one Claim record | |
| Secondary | Must be associated to one Provider record | |
| Provider | May be associated to one or more Visit records | |
| | Must be associated to one Claim record | |
| Special | Must be associated to one or more Visit records | |
| Diagnostic | | |
| Procedures | | |
| Special | Must be associated to one Provider record | |
| Evaluations | Must be associated to one or more Visit records | |
| Surveillance | May be associated to one PI Assignment record | |
| History | | |
| Visit | Must be associated to one Claim record | |
| | May be associated to one or more Obj Findings | |
| | records | |
| | May be associated to one Secondary Provider | One Visit record may be |
| | record | associated to only one |
| | May be associated to one Special Evaluations | choice of these 4 types |
| | record | of records, or it can be |
| | May be associated to one Special Diagnostics | associated to none of |
| | Procedures record | them if the check box |
| | May be associated to one Hospitalization record | for Primary Provider is |
| | | selected. |

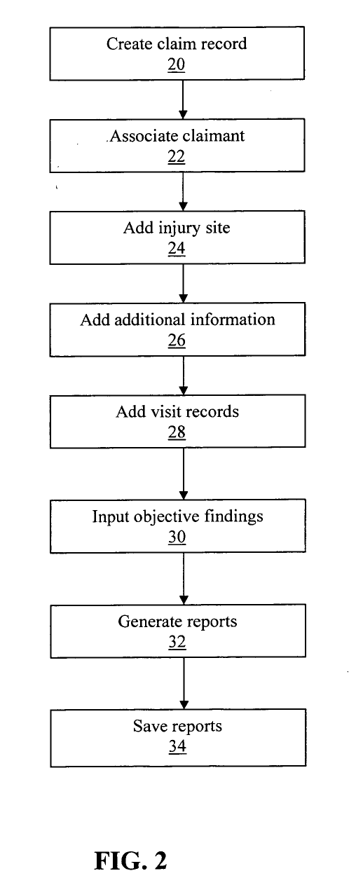

In a preferred embodiment of the invention, an initial standard workflow operation is creating a Claim. In the creating a claim operation, the user enters data about Claims and Visits into Claim Alert system 10 with the goal of generating reports from the data. The following discussion explains preferred steps illustrated in FIG. 2 for creating a Claim and its associated records. A Claim record contains the measurement data of claim files specific to a Claimant. A claim file is the collection of data sets related to a specific claimant for (an) injury(ies) that occurred on a specific date.

In create claim record step 20, a new Claim record is created. In associate claimant step 22, the Claim is associated to a Claim file by the date of injury. In add injury site step 24, the user adds an Injury Site record to the Claim. In add additional information step 26, the user adds the following records to the Claim if available: (a) Insurance Carrier, (b) Attorney for the Carrier, (c) Attorney for the Claimant, (d) Primary Provider, (e) Secondary Provider, (f) Adjuster, (g) Private Investigator (PI) Assignment, (h) Reviewer, (i) date injury reported, (j) location of first visit, (k) Carrier assigned claim identification number and user claim identification number and (l) Employer.

In add visit records step 28, the user adds Visit records to the Claim. In this embodiment, only one type of Provider is allowed to be selected per Visit record. Preferably, all known Secondary Providers are added to the Claim record first before this operation is performed, so they are available as choices on the Visit record. If Primary Provider is the Provider type selected, the Primary Provider record with the dates overlapping the Visit date is preferably used.

In input objective findings step 30, the user fills in the medical provider's objective measurements during a Visit in the Objective Findings records generated with that Visit. Initial Objectives Findings records are based on the data stored in the Injury Sites records and the AAOS and AMA Standards records.

Once Visit records have been created, reports may be generated about the Claim in generate reports step 32. The user may then save each report in save reports step 34 as a portable document format (PDF) file in the Saved Report records associated with the Claim.

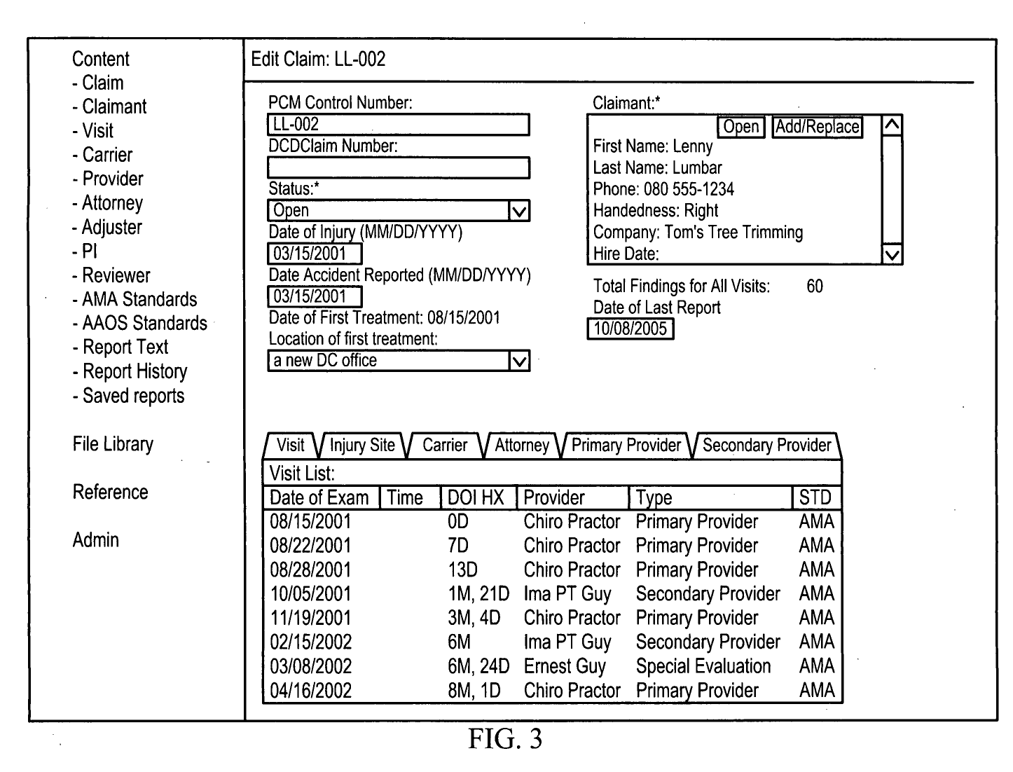

Referring to FIG. 3, a representation of a screen shot shows a preferred Edit Claim window and its display of associated records. The user may maintain (update) each Claim record or Claim file as needed at any point by selecting an existing Claim record from the Claim Grid window.

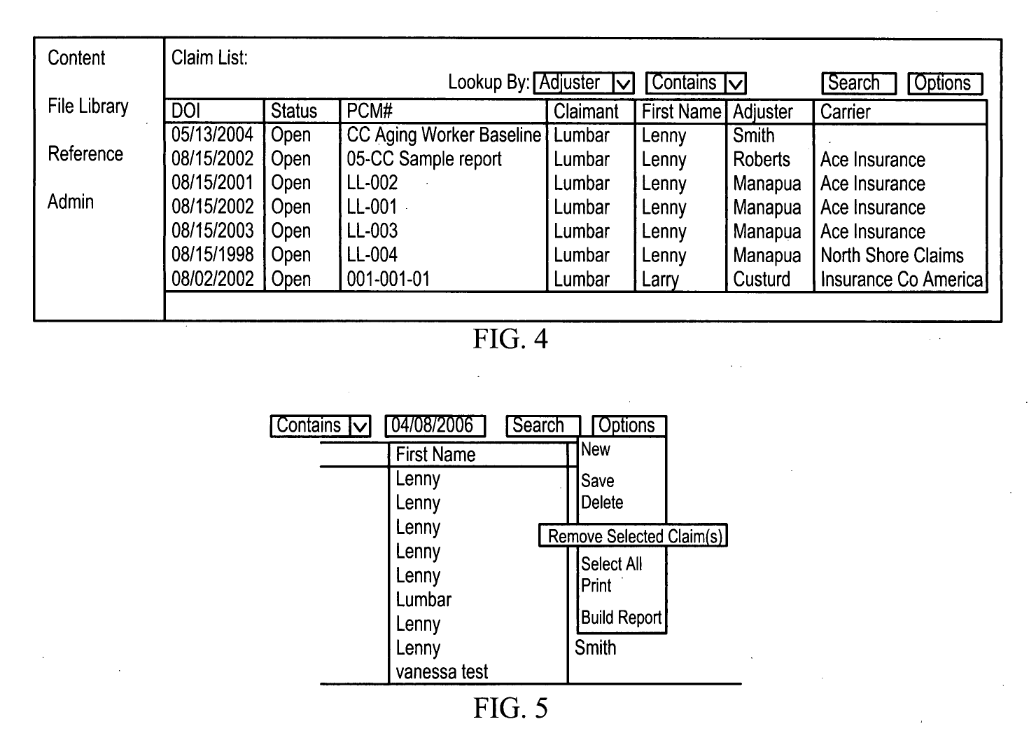

Referring to FIG. 4, a representation of a screen shot shows a preferred Claim List (Claim Grid) window. This is preferably the opening/start window of the application, that is, the window that is displayed to the user after login. The Claim Grid window allows the user to search for selected claim files. The Claim Grid displays all Claim files that meet the search criteria. A Claim file is associated with one Claimant for one date of injury (DOI). Thus, a Claim record includes all Claim files that are specific to a Claimant. A Claim file includes all collected data that are specific to a Claimant and to all injuries that occurred on a specific date of injury. Therefore, a Claim record for John Doe, SSN-555-55-5555, may have one to many Claim files, e.g., the Claim record for John Doe, SSN-555-55-5555, contains has Claim files for 12 Jan. 1995, 10 Oct. 2001 and 25 Jun. 2006. Multiple Claim files may be open and active in a Claim record.

A Claim file may have any number of injuries, treatment providers, evaluation types, evaluation dates, attorneys, and PIs. Because each Claim file is date specific for a claimed injury, the user can identify treatments that occurred before the claim date and identify the number of days the treatment occurred before the injury was claimed. This is valuable information to identify pre-existing injuries and non-claim-related treatments that may be billed by the medical providers. Treatments are preferably input in the TX NOTES field when a new Objective Finding is created. The user can also get to this screen by double clicking any entered visit date in a Claim file “Visit” tab. If any notes are entered in a Claim file visit date, they are reported in the narrative report under “Special Events—by date and provider.”

Referring to FIG. 5, a representation of a partial screen shot showing the options drop-down menu of a preferred Claim Grid window is presented. The user may delete any Claim record as needed by using the “Options” choices. Available options preferably include: “New” Exam Entry, Save, Delete, Refresh, Select All and Print. The Build Report option is preferably only available when the user is in a Claim file. This is to insure that only the appropriate data are collected from a specific claim to build a report.

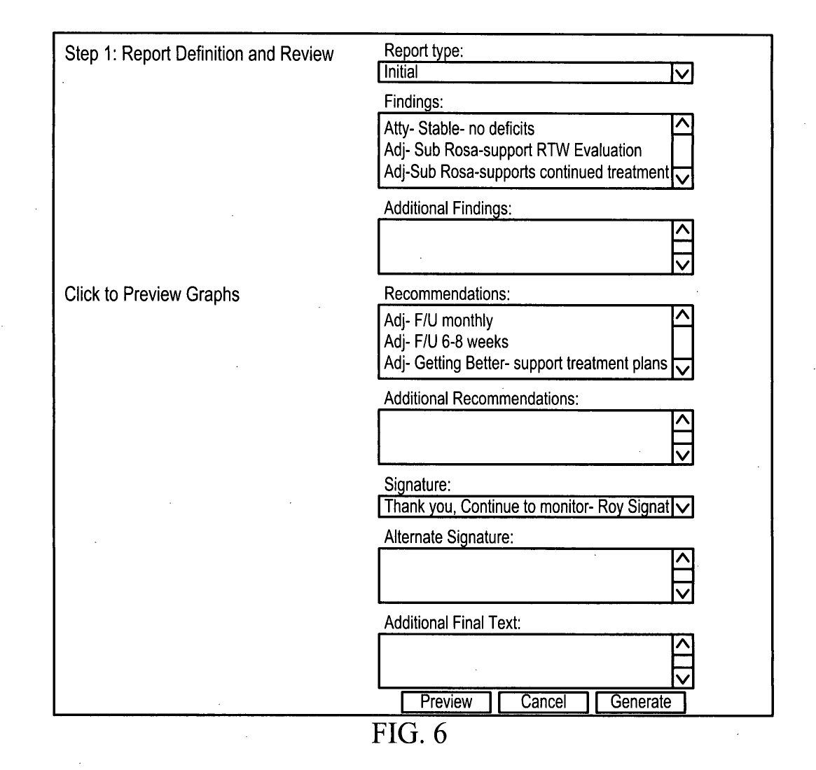

In a preferred embodiment of the invention, four types of reports may be generated for any Claim record. Each report preferably includes a section containing graphs that plot the measurements from the Objective Findings records of a Claimant over time for any injury reported. The report may also include Summary sections that show history of categorized data, such as the date of the initial visit with objective data to the date of the report, and some aggregation of data as appropriate for the report, such as the claim age of the Claim file from the date of the injury to the date of the report. To generate a report on any Claim, the user may either open the Claim record, or select that Claim record in the Claim grid. The user then selects “Build Report” from the Options drop down menu (see FIG. 5) and Report Wizard window appears (see FIG. 6). The user can preview the graphs for the report by clicking on the Preview button on the Report Wizard or on the graphic image of the report. The user can also analyze and comment on the graphs depicting the progress of the Claimant's recovery as measured by the Objective Findings records.

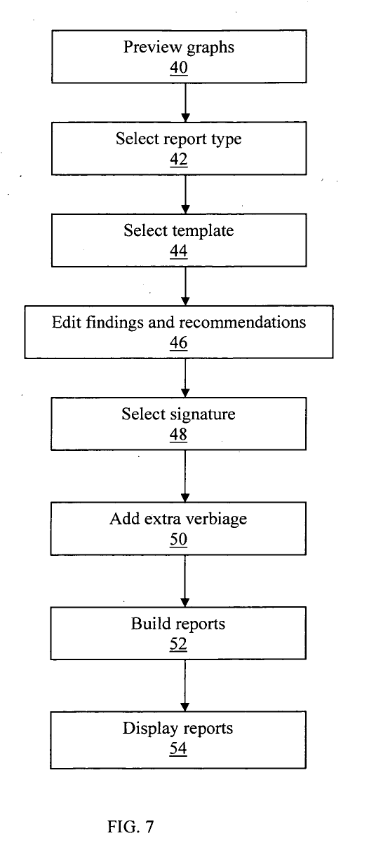

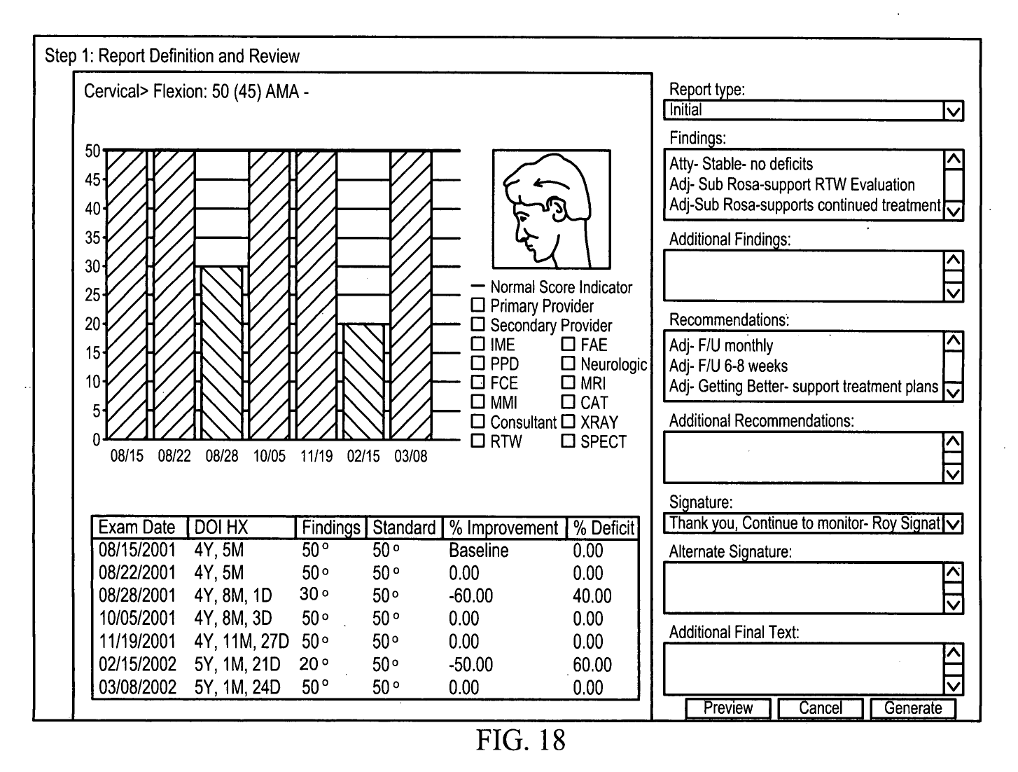

In a preferred embodiment of the invention, another workflow operation is report specification. In this embodiment, the Report Wizard (see FIG. 18) steps the user through the report specification operation illustrated in FIG. 7. In preview graphs step 40, the user previews the automatically-generated graphs of the Objective Findings (measurements) for a selected Claim. In select report type step 42, the user chooses the type of report to generate from among the following preferred report types: Initial report, Follow-up report, Injury History report and Special Comprehensive report.

In select template step 44, the user selects from pre-loaded templates of common Findings and Recommendations. In edit findings and recommendations step 46, the user adds unique and additional Findings and Recommendations to the report. In select signature step 48, the user selects a template signature or creates a unique one. In add extra verbiage step 50, the user adds any extra verbiage to the bottom of the report after the signature line, if desired

Once all the selections have been made, the user clicks “Generate.” The report engine builds the selected type of report in build report step 52, and the report appears in a new browser window in a .PDF format in display report step 54. The user optionally saves the report to random access memory 19.

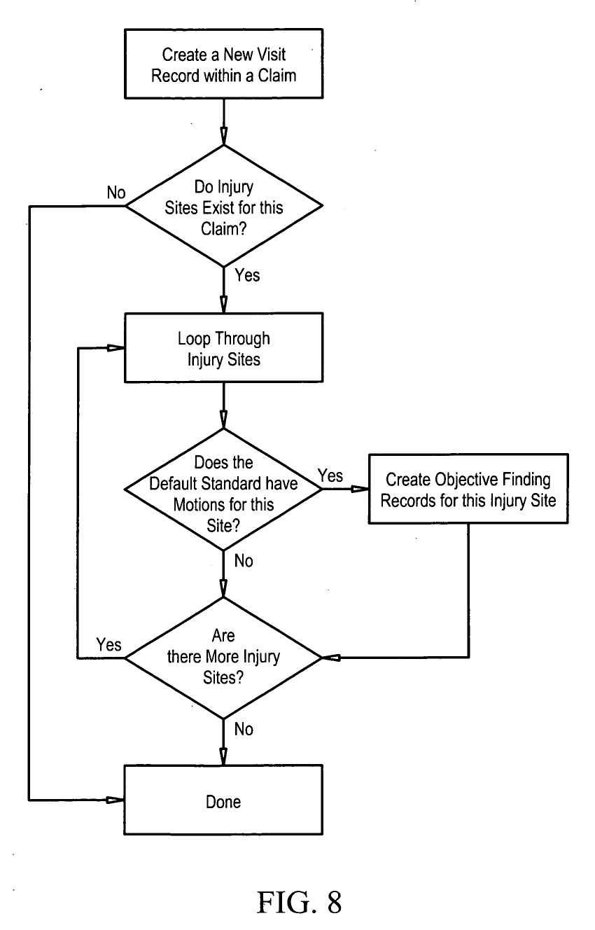

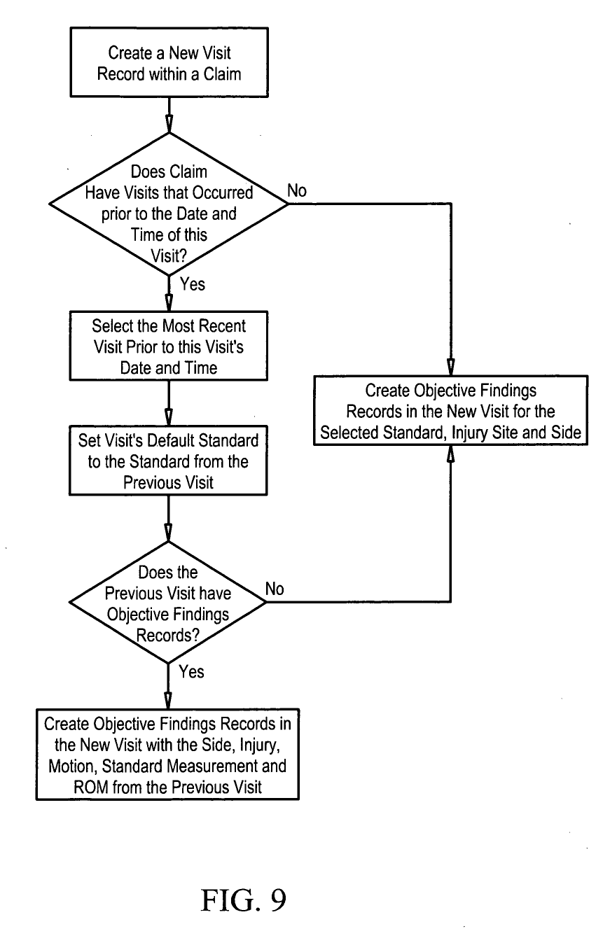

When creating a new Visit record, the user enters the date and time for the Visit. To speed data entry, system 10 (in accordance with the program instructions of Claim Alert software application) derives a set of Objective Finding records for each Visit that are “empty” in the sense that they do not contain range of motion measurements. The user either selects a default standard (AMA or AAOS) or opts to use the previous Objective Findings from a prior Visit. When there is no prior visit, the application performs the use default objective findings operation illustrated in FIG. 8 to check the records stored in the AMA Standards and AAOS Standards entities to determine what Objective Findings (i.e., measurements of motions) a health care provider should record to evaluate a particular injury. The application looks for Standards records with an Injury field that matches the Injury fields in the Injury Site records of the Claim. If the previous visit does exist with the exact same objective findings as the current visit data and the use previous objective findings is selected, the application performs the operation illustrated in FIG. 9 to populate the Objective Findings records.

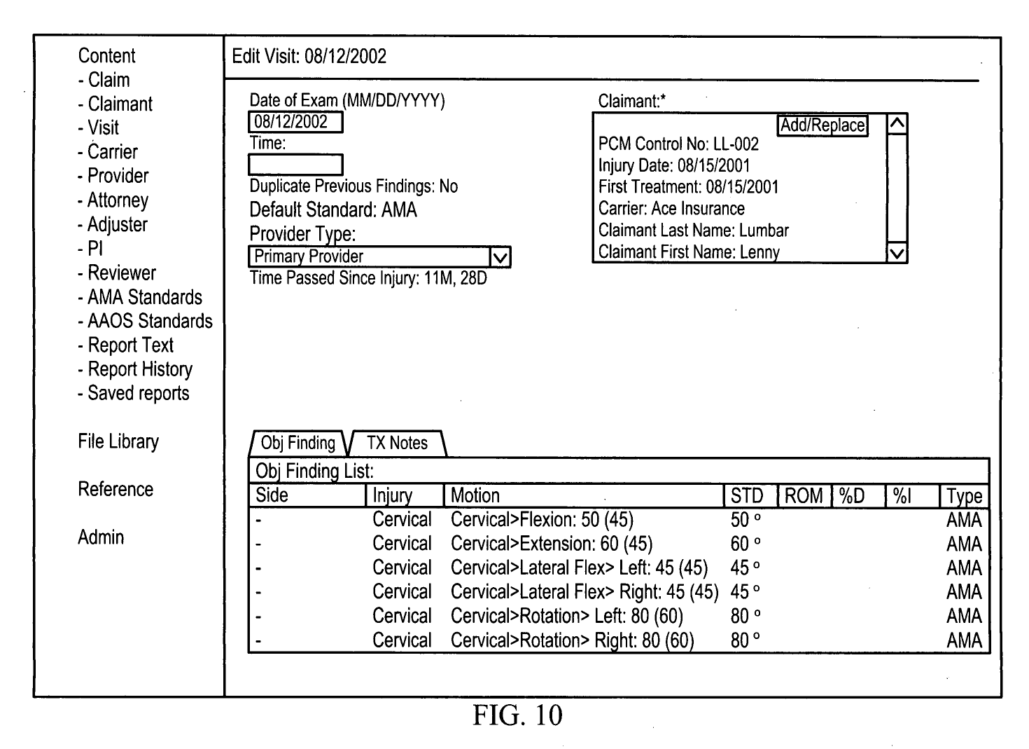

Referring to FIG. 10, a representation of a screen shot showing a typical Edit Visit window and its display of associated Objective Findings records is presented in accordance with a preferred embodiment of the invention. With either scenario for generating objective findings (in accordance with the method of FIG. 8 or FIG. 9), the appropriate empty Objective Findings records are generated for a Visit, with Side, Injury, Motion, Standard Measurement and Type fields populated, as shown in this typical representation of a screen shot. If the user opts to duplicate previous findings, the patient's measured Range of Motion (ROM) measurement fields are also populated and, hence, the Objective Findings records are no longer empty.

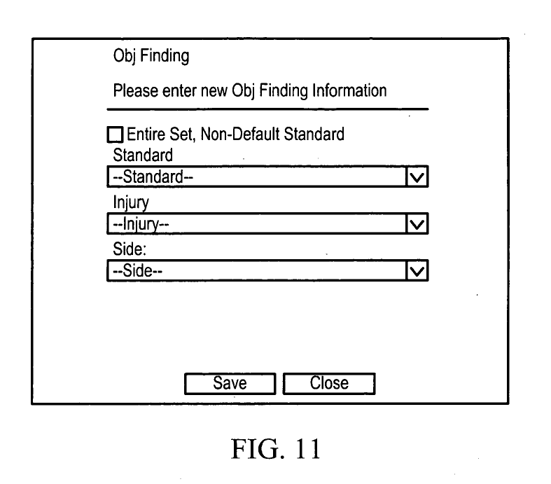

Referring to FIG. 11, a representation of a screen shot showing a typical Enter Additional Objective Finding window is presented in accordance with a preferred embodiment of the invention. If the user wants to enter one or more additional empty Objective Findings records after the initial set is generated, he or she has the option of either creating a set of empty Objective Findings records for a non-default standard, or picking a specific standard, injury and side.

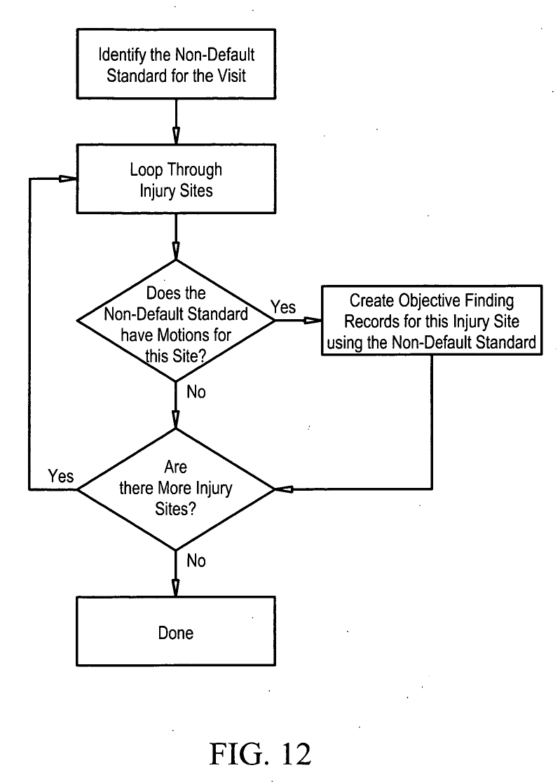

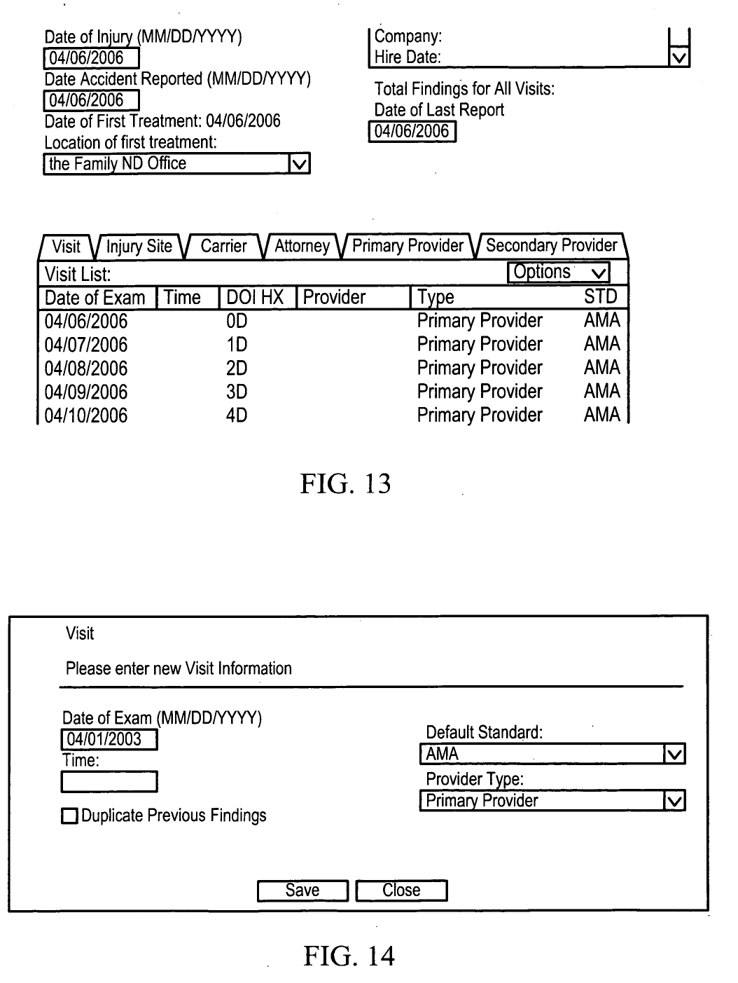

Referring to FIG. 12, a schematic block diagram of a create non-default objective findings operation of a preferred embodiment of the invention is presented. In this operation, the user creates an entire set of empty Objective Finding records for each injury site based on a specified non-default standard. FIG. 13 presents a Visit List screen showing Visits for which the AMA Standard was set from the original Injury input screen as the standard for evaluations. Each time this provider is used, when a New Visit is generated, system 10 automatically fills the data entry screen with the known injury and the known standard. If the provider uses the standard, then no changes are needed.

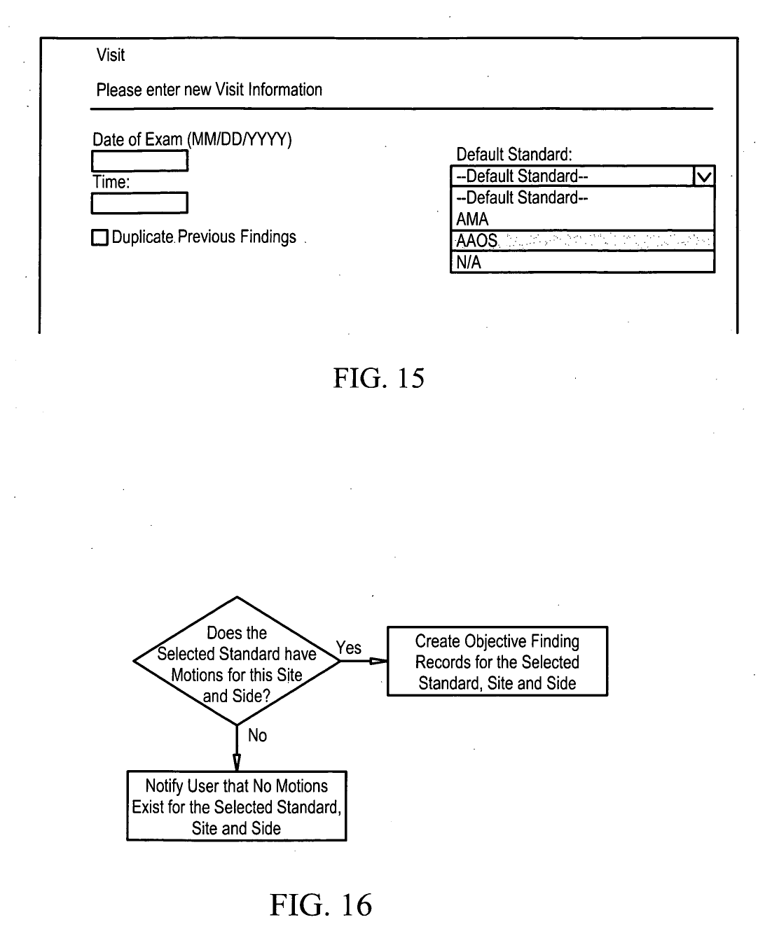

Referring to FIG. 14, a representation of a screen shot showing a typical New Visit screen is presented. In this situation, the user inputs information on a different provider with a different standard and the time the visit occurred. FIG. 15 shows a standard selection drop down menu for the typical New Visit screen of FIG. 14. The user uses this menu to select the standard used by this provider.

Referring to FIG. 16, a schematic block diagram of a check for motions operation of a preferred embodiment of the invention is presented. The user selects a specific standard, injury and side for creation of additional empty Objective Findings records. After the empty Objective Findings records have been generated, the user simply has to key in the Range of Motion (ROM) or other measurements reported by the medical provider.

Because each injury motion is unique to each individual based on the standards, system 10 generates the percent deficit and percent improvement for each injury motion based on the selected standard. Also, the graphs reflect the correct selected standard. For example, if the AMA Standard for a motion is 20 degrees and the AAOS standard for the same motion is 40 degrees, then a finding of 30 degrees would be above one standard and below the other. System 10 performs the calculations for both standards if both are used in a Claim file, but the user lets the application know there are two standards used for the claim. In this way, the user is ensured a reliable percentage of deficit and percentage of improvement based on the standard, not on the measurement. System 10 can accommodate this difference without the user's having to create a separate Claim file for each standard. The user can dispel the argument that the data are skewed to only one set of standards (even though the AMA standard is at present the only legal standard), the client has provided the measurements relative to both standards.

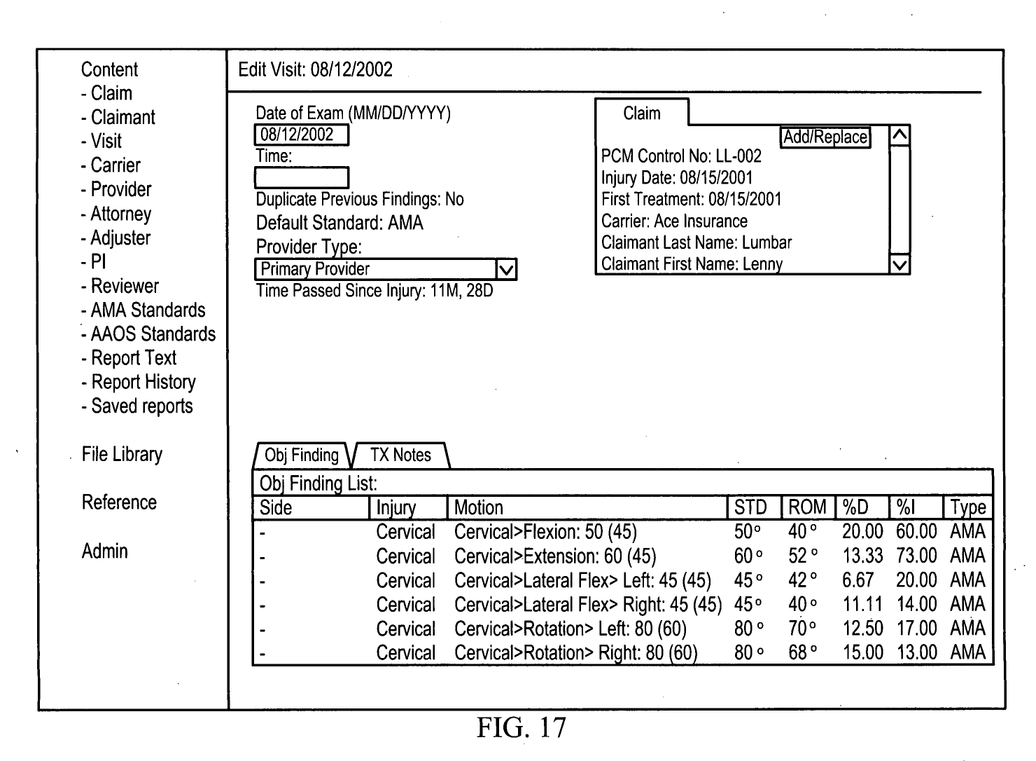

Referring to FIG. 17, a representation of a screen shot showing a typical Edit Visit window with calculated objective findings is presented in accordance with a preferred embodiment of the invention. Upon clicking on the Save button after the user enters ROM values, system 10 calculates the Percent Increase from the baseline measurement and the Percent Deficit from the standard. The following is a list of the preferred calculated fields in the Claim Alert application:

Objective Finding—Percent Deficit: This calculation shows how far from the standard a patient's measurement is. The percent deficit is the standard minus the patient's measurement, divided by the standard.

Objective Finding—Percent Improvement: This calculation shows how much a patient's range of motion has improved or decreased from the first measurement taken. The percent improvement is the current measurement minus the patient's original measurement for this motion, divided by the original measurement.

Objective Finding—Non-Affected Percent Deficit: If the medical provider also measured the non-affected side for a particular injury, the system calculates the percent deficit for this measurement in the same way it does for the affected side. For example, if a patient has injured his left elbow, and a medical provider may measure the range of motion of his right elbow for comparison purposes and to assess whether the patient's elbows normally have a full range of motion.

Objective Finding—Non-Affected improvement: This is the calculated percent improvement of the patient's range of motion for the non-affected side.

DOI HX—Time Passed Since Injury: This field presents a calculation of how much time passed between the date of the injury and the date of the recorded visit to the medical provider, e.g., 11 months and 28 days.

Claim—Total Findings for All Visits: This field displays how many Objective Findings measurements have been recorded over all the Visits for a Claim from the initial visit to the date of the report.

In a preferred embodiment of system 10, four types of reports may be created using the Claim Alert application. They are as follows: General (Initial) Report, Follow-up Report, Injury History Report, and Special Comprehensive Report.

In a preferred embodiment, the Initial Report comprises the following information: (1) name and address of carrier and adjuster, (2) report date, (3) reviewer name and contact information, (4) summary information about the claim and the claimant, (5) reviewer's findings, recommendations and additional information, (6) summary of the initial findings measurements, (7) summary of the most recent findings measurements, (8) summary of the claimant's history of visits, (9) history of special evaluations, hospitalizations, and special diagnostic procedures and (10) history of private investigation reports.

In a preferred embodiment, the Follow-up Report comprises the following information: (1) name and address of carrier and adjuster, (2) report date, (3) reviewer name and contact information, (4) summary information about the claim and the claimant, (5) reviewer's findings, recommendations and additional information, (6) summary of the most recent findings measurements, (7) summary of the claimant's history of visits since the last report was generated, (9) history of special evaluations, hospitalizations, and special diagnostic procedures since the last report was generated and (10) history of private investigation reports since the last report was generated.

In a preferred embodiment, the Injury History Report comprises the following information: (1) name and address of carrier and adjuster, (2) report date, (3) reviewer name and contact information, (4) summary information about the claim and the claimant, (5) reviewer's findings, recommendations and additional information and (6) summary of injuries information from any past claims or as reported in the history of previous injuries record associated with this claimant.

In a preferred embodiment, the Special Comprehensive Report comprises the following information: (1) name and address of carrier and adjuster, (2) report date, (3) reviewer name and contact information, (4) summary information about the claim and the claimant, (5) reviewer's findings, recommendations and additional information, (6) summary of the most recent findings measurements, (7) summary of the claimant's history of visits, (8) history of special evaluations, hospitalizations, and special diagnostic procedures, (9) list of any additional injuries identified after the initial visit, (10) history of previous injuries and previous claims, (11) history of private investigation reports, (12) list of accident facts entered into injury site records, (13) list of any treatment notes from the providers that were entered into the visit records.

In a preferred embodiment, the user creates Report Text records in the application for commonly used Findings, Recommendations, and Signatures. These Report Text records may then be used as selectable templates for inclusion in any of the Reports.

The Claim Alert reporting module is preferably implemented as a custom wizard-style Java web application. It preferably comprises two major Java Server Page (JSP) pages which interface with the One Team Virtual (OTV) reporting engine in order to create the Claim Alert report. To implement the invention, one may use any report generating technology, e.g., Crystal Reports, WWW Domain store.businessobjects.com/store/bobjects/ContentTheme/pbPage.home to create the report. In one embodiment, the report generating technology from One Team Technology Corporation, Chicago, Ill. is used.

In a preferred embodiment, the Build Report JSP page shown in FIG. 18 is the page the user sees when he or she launches the report generation process by selecting the “Build Report” option from a Claim inside of the Claim Alert application. This page is used to collect any user-defined information that is to be displayed in the report, as well as to preview the graph portion of the selected report, which aids in determining the findings, recommendations, and additional comments that are to appear in the report. It is also used to select what kind of report is to be created. Thus, the initial page in the report module is used to define the report and details that will appear inside the report.

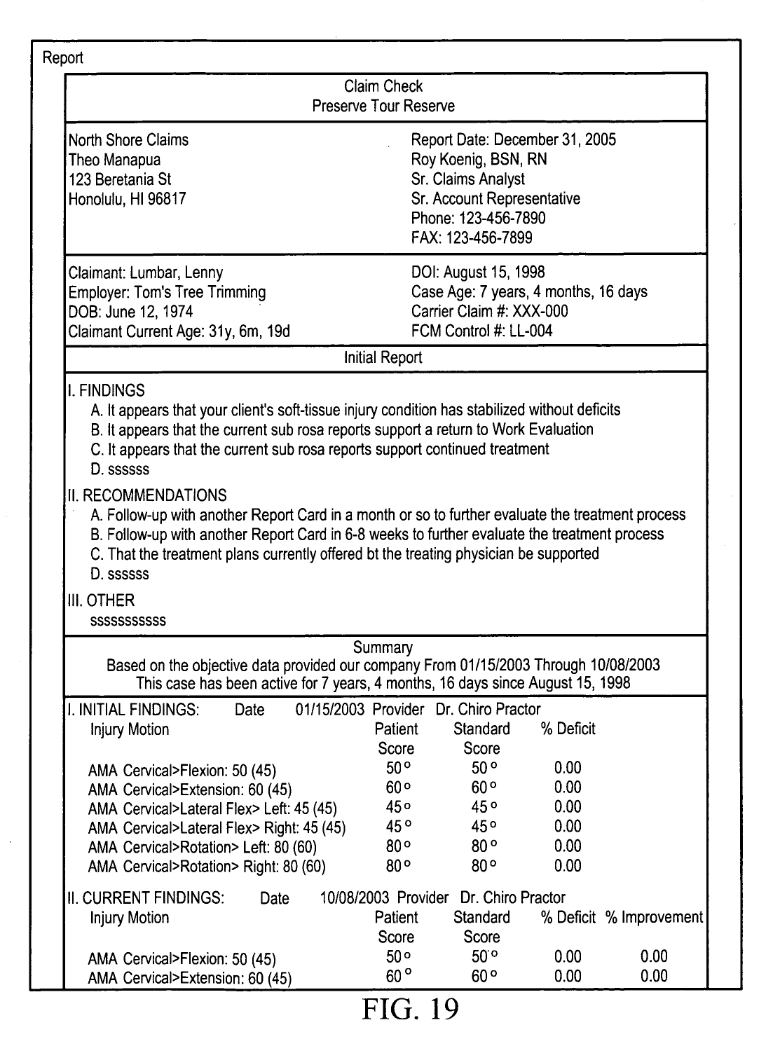

Referring to FIG. 19, a representation of the Preview Report JSP page is illustrated, which acts as an interface between the Claim Alert report wizard and One Team's Java report servlet. When the user previews a report, a request is sent to the Java servlet to display the preview, which is preferably a report in and of itself. Once the user has previewed the report and entered all of the desired information, the user may initialize the final report generation process using the “Generate” button on the jsp page. This submits all of the entered information to the next jsp page, which stores all of the entered information in a Java object which is passed to One Team's reporting engine via the Java session object and is retrieved at run time in order to display the entered data along with the data from the selected Claim.

In an alternative embodiment, the data are collected from the medical files using a Personal Digital Assistant (PDA) that allows the collection of necessary data to include demographic data at the client's office. The collected data are preferably uploaded directly from the PDA to a remote server and downloaded into the application disclosed herein.

In another alternative embodiment, the system 10 obtains data collected from medical reports from medical claim files stored on virtual protected networks and converts the collected data and sorts it into applicable collection fields that are downloaded into the application disclosed herein. The collected data are used to auto-create the claim file and populate the appropriate data fields with the collected data. The completed report is electronically transmitted to the virtual medical claims file and/or allows for identification of outlier cases and utilization issues as constrained by the third-party applications.

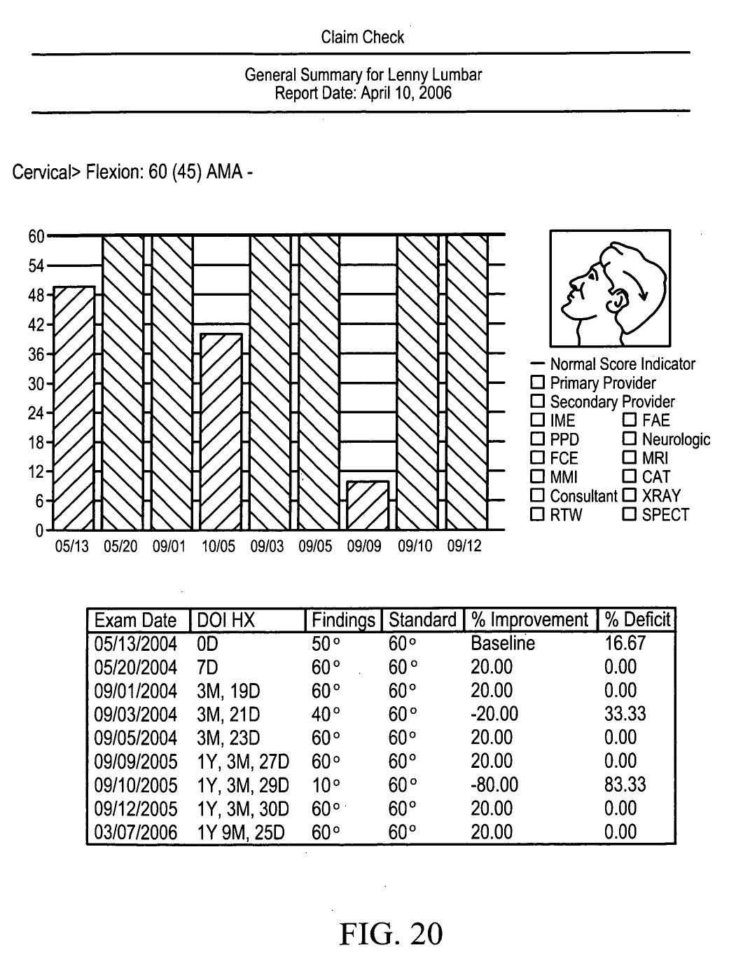

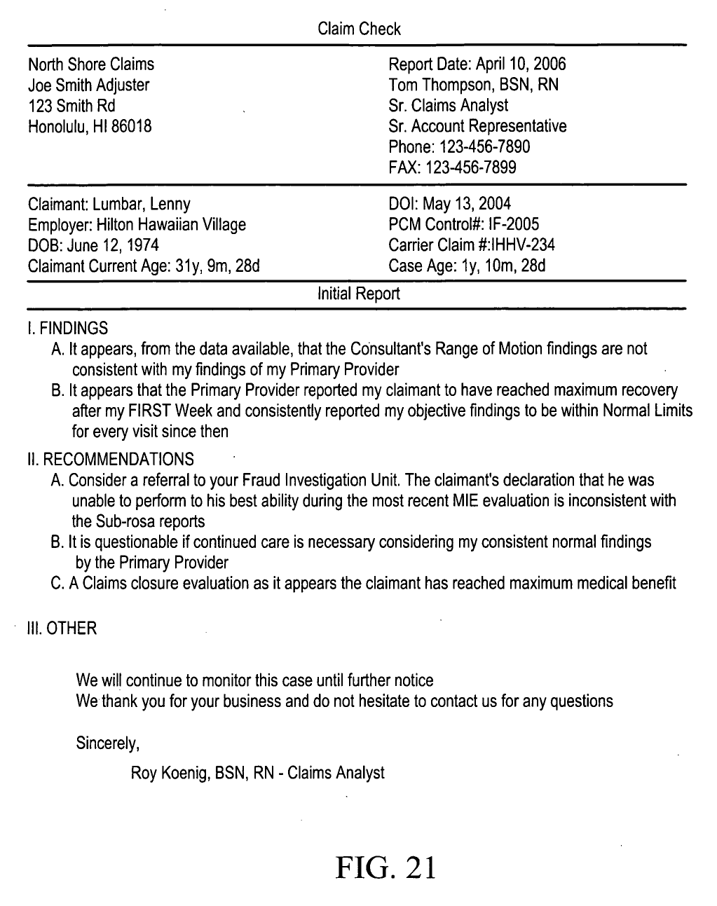

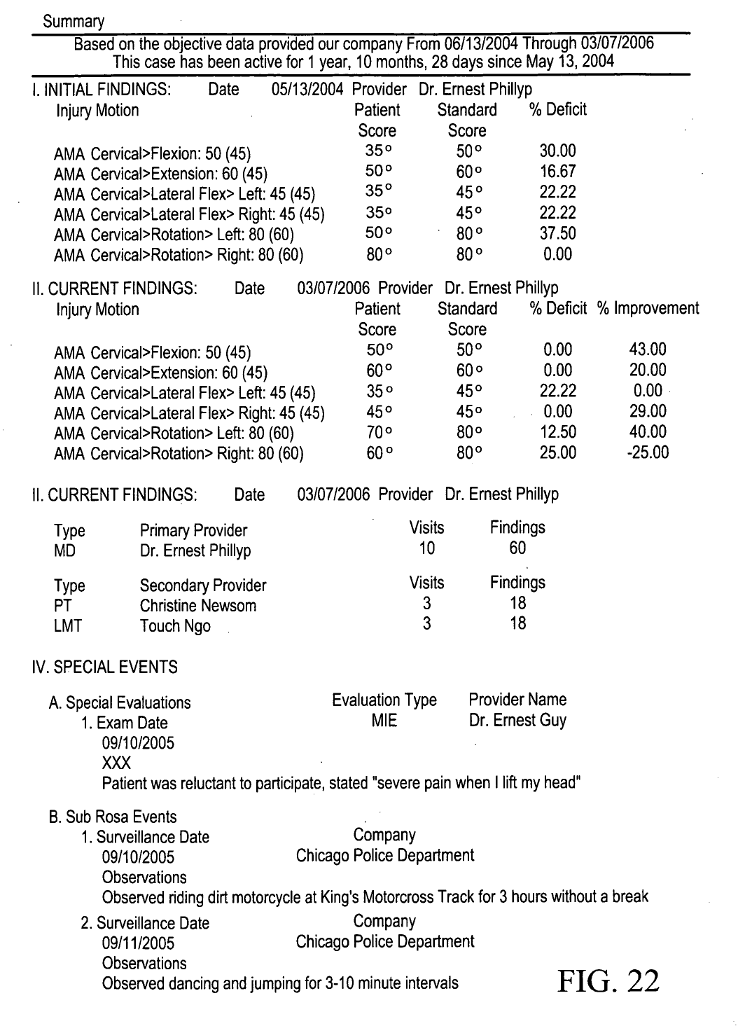

FIG. 20 is an example of a graphic report in accordance with a preferred embodiment of the invention. FIG. 21 is an example of the first page of an Initial Report in accordance with a preferred embodiment of the invention. FIG. 22 is an example of the second page of an Initial Report in accordance with a preferred embodiment of the invention.

In another alternative embodiment, the data are collected from medical reports from scanned files that identify objective data and converts the collected data and sorts into applicable collection fields. The scanned data are preferably uploaded to a remote server and downloaded into the application disclosed herein.

In another alternative embodiment, system 10 has the ability to import and integrate third party applications to enhance the report generator. Preferably, the report generator can produce interactive files; allows selective reports by time, and or provider and or injury and or evaluation type; and/or allows the comparison of findings by provider types over selective treatment dates. In yet another alternative embodiment, a “mouseover” of an online report image results in the production of a video file of an anatomical representation of the injury site that reflects the changes in the motions of the collected objective data over time.

In another alternative embodiment, the invention involves documenting initial objective findings for new hires to establish a baseline for each new hire and comparing the baseline to a standard. In this embodiment, changes in each employee's baseline are monitored over time, e.g., at five- or ten-year intervals. System 10 preferably displays a separate screen for each type of objective finding (measurement) and on that screen displays a graphical comparison of a series of measurements to a standard and a tabular listing that includes a date of measurement, a time since injury, a finding (differentiated by type of provider or type of test), an accepted standard, a percent improvement from a baseline (preferably, the baseline immediately before the injury) and a percent deficit from a standard.

The invention provides a number of benefits to its users. If the display of analyzed objective findings shows that the injured worker is performing better and at the level of an appropriate standard, return-to-work protocols can be initiated. If the display of analyzed objective findings shows that the injured worker is getting worse, his treatment plan can be reassessed. If the display of analyzed objective findings shows that the injured worker is performing at a level that is lower than an appropriate standard, but is stable, return-to-work protocols can be initiated along with an independent functional capacity evaluation.

In an alternative embodiment, system 10 calculates the claimant's current biological age at the date of the report, a variable that is useful in determining age related factors to the healing process. In addition, in preferred embodiments, each report is age dated in years, months and days to the date of the accident from the date of the report so the reader can immediately determine how long the claim has been active and open. Preferably, each visit displayed on the bar graph reports is age dated to the date of the accident. This is helpful in determining the length of time between treatments. In other preferred embodiments, system 10 counts and displays the number of visits per provider to include the number of cumulative objective findings for each provider. This is helpful in detecting over or under utilization of services by types of providers. In other preferred embodiments, system 10 differentiates the percentage of improvement or deficit by types of providers. This is helpful when comparing the objective findings of treating physicians and independent medical evaluation physicians. In other preferred embodiments, system 10 summarizes the findings of sub-rosa events in a date chronological order. This is helpful in determining relationships between treatment activities and investigated physical activities over a known date or dates. In other preferred embodiments, special evaluations provided by non-treating providers are summarized with a report of their findings. This is helpful for the reader to understand the relationship of the findings by all non-treating physicians and the number of special evaluations that occurred during the life of the claim. The application can preferably distinguish the objective findings of various types of special evaluations including, but not limited to, independent medical evaluations, permanent partial disability ratings evaluations, return to work evaluations, maximum medical improvement evaluations, and functional capacity evaluations. The “Other” category in the selection menu allows for unlimited types of comparisons. This is helpful for the reader to understand the relationship between the findings of one type of special evaluation and another type and against the findings of the treating providers. In another embodiment, system 10 is able to isolate and display specific visit and treatment data when the user clicks on the bar graph representation in the built report. This gives the user the ability to isolate data rapidly from the report for detailed analysis. In another embodiment, system 10 is capable of compiling a follow-up report based solely on records entered since the date of the last report. This gives the user the ability to compile updated information from the file without reproducing the volumes of paperwork associated with previous reports. In another embodiment, system 10 is capable of identifying possible soft-tissue injury fraudulent behaviors of the claimant and providers based on the objective findings by providers and visit dates.

### WORKING EXAMPLE

Because of the applicant's unique background of nursing, claims adjusting, and a plaintiff paralegal, he saw the need to produce the system and method disclosed herein. Discussions with claims adjusters and attorneys involved in workman's compensation cases showed that unless one had a strong medical background, the “objective” data of a soft-tissue injury were just numbers. By displaying the cumulative “numbers” in a format that accurately reflected the medical providers objective findings, they were surprised to see how easy it was to determine at a glance if the claimant was getting better, getting worse, or had stabilized. With the information, they could take actions to manage the case efficiently.

A pilot project of 33 cases resulted in the closure of 28 cases whose average claim age was over 9 years. In the remaining 5 cases, the claims reserves were lowered due to the findings of the “objective” reports. The project displayed that a simple, informative, accurate report of the objective information available in a claims file would have been extremely valuable if they had implemented a monitoring program early in the claim. One case that had been open for 22 years could have easily been closed after 4 years. The insurance company had paid for services for over 18 years for treatment of an injury that the medical provider had characterized as “normal” in “objective” terms.

Many variations of the invention will occur to those skilled in the art. Some variations include calculating the affected percent deficit by comparing a measured range of motion to a standard. Other variations call for calculating an affected percent improvement by comparing a first measurement taken on a first visit date to a second measurement taken on a subsequent visit date. Yet other variations call for calculating a non-injured percent deficit for a type of motion by comparing a subsequent measured range of said type of motion to a standard, and a non-injured percent improvement by comparing said first measurement to a second measurement. Other variations call for comparing measurements of an injured motion to an uninjured motion of the companion body part that has a companion such as the left and right elbow. Another variation is the integration of this application with industry standard databases of utilization standards such as the Work Loss Data Institute database to determine over or under utilization of services by provider types to identify any breech of national, state or local standards of utilization. All such variations are intended to be within the scope and spirit of the invention.

Although some embodiments are shown to include certain features, the applicant specifically contemplates that any feature disclosed herein may be used together or in combination with any other feature on any embodiment of the invention. It is also contemplated that any feature may be specifically excluded from any embodiment of the invention.

What is claimed is:

1. A computer-implemented method for evaluating a soft-tissue injury claim, said method comprising:
creating a claimant record;
creating a claim record and associating it with said claimant record, said claim record being further associated with at least one injury site record and optionally being further associated with a carrier record, a provider record, an attorney record, an adjuster record, a private investigator record and a reviewer record;
inputting an injury site to said at least one injury site record;
associating a first visit record with said claim record;
selecting a standard and creating a first objective findings record that is associated with said first visit record and said at least one injury site record;
inputting a first measurement characterizing said injury site from said first visit into said first objective findings record;
associating a second visit record with said claim record;
creating a second objective findings record that is associated with said second visit record and said injury site record;
inputting a second measurement characterizing said injury site from said second visit into said second objective findings record;
calculating a percent deficit for each measurement by comparing each measurement to said standard, and a percent improvement by comparing said first measurement taken on a first visit to said second measurement taken on said second visit to produce a plurality of calculated objective findings; and
generating a report that presents each of said measurements and each of said calculated objective findings in a graphical format and/or a tabular format.

2. The method of claim 1 wherein said claim record is further associated with a non-injured side record and the method further comprises:
selecting a standard and creating a third objective findings record that is associated with said first visit record and said non-injured side record;
inputting a first non-injured side measurement characterizing said non-injured side from said first visit into said third objective findings record;
creating a fourth objective findings record that is associated with said second visit record and said non-injured side record;
inputting a second non-injured side measurement characterizing said non-injured side from said second visit into said fourth objective findings record;
calculating a non-injured percent deficit for each non-injured side measurement by comparing each non-injured side measurement to said standard, and a percent improvement by comparing said first non-injured side measurement taken on a first visit to said second non-injured side measurement taken on said second visit to produce a second plurality of calculated objective findings.

3. A computer-implemented method for evaluating a soft-tissue injury claim, said method comprising:
inputting a claimant;
creating a claim and associating it with said claimant and with an injury site;
associating a first visit with said claim;
selecting a standard;
inputting a first measurement characterizing said injury site from said first visit;
associating a second visit with said claim;
inputting a second measurement characterizing said injury site from said second visit;
calculating a percent deficit for each measurement by comparing each measurement to said standard, and a percent improvement by comparing said first measurement taken on a first visit to said second measurement taken on said second visit to produce a plurality of calculated findings; and
generating a report that presents each of said measurements and each of said calculated findings in a graphical format and/or a tabular format.

4. The method of claim 1 wherein said claim is further associated with a non-injured side and the method further comprises:
inputting a first non-injured side measurement characterizing said non-injured side from said first visit;
inputting a second non-injured side measurement characterizing said non-injured side from said second visit;
calculating a non-injured percent deficit for each non-injured side measurement by comparing each non-injured side measurement to said standard, and a percent improvement by comparing said first non-injured side measurement taken on a first visit to said second non-injured side measurement taken on said second visit to produce a second plurality of calculated findings.

5. A computer-implemented method for evaluating a soft-tissue injury claim, said method comprising:
a step for creating a claimant record;
a step for creating a claim record and associating it with said claimant record, said claim record being associated with an injury site record;
a step for inputting an injury site to said injury site record;
a step for associating a first visit record with said claim record;
a step for selecting a standard and creating a first objective findings record that is associated with said first visit record and said injury site record;
a step for inputting a first measurement characterizing said injury site from said first visit into said first objective findings record;
a step for associating a second visit record with said claim record;
a step for creating a second objective findings record that is associated with said second visit record and said injury site record;
a step for inputting a second measurement characterizing said injury site from said second visit into said second objective findings record;
a step for calculating a percent deficit for each measurement by comparing each measurement to said standard, and a percent improvement by comparing said first measurement taken on a first visit to said second measurement taken on said second visit to produce a plurality of calculated objective findings; and
a step for generating a report that presents each of said measurements and each of said calculated objective findings.

6. The method of claim 5 wherein said report comprises a bar graph having a bar that represents each measurement.

7. A computer-implemented method for evaluating a condition, said method comprising:
selecting a protocol that characterizes a severity of the condition, and identifying a standard result of performing said protocol on a patient that does not have the condition;
inputting a plurality of visit records, each visit record comprising a visit date, and a measurement of said severity obtained by having said patient perform said protocol;
calculating a percent deficit by comparing said measurement to said standard result, and a percent improvement by comparing one measurement taken on a first visit date to another measurement taken on a subsequent visit date to produce a plurality of objective findings; and
generating a report that presents each of said objective findings.

8. The method of claim 7 wherein said report presents said one measurement and said another measurement in a time sequence.

9. The method of claim 8 further comprising:
adding a finding and/or a recommendation to said report.

10. A computer-implemented system for evaluating a soft-tissue injury claim, said system comprising:
means for creating a claimant record;
means for creating a claim record and associating it with said claimant record, said claim record being associated with at least one injury site record and optionally being associated with a carrier record, a provider record, an attorney record, an adjuster record, a private investigator record and a reviewer record;
means for inputting an injury site to said at least one injury site record;
means for associating a first visit record with said claim record;
means for selecting a standard and creating a first objective findings record that is associated with said first visit record and said at least one injury site record;
means for inputting a first measurement characterizing said injury site from said first visit into said first objective findings record;
means for associating a second visit record with said claim record;
means for creating a second objective findings record that is associated with said second visit record and said injury site record;
means for inputting a second measurement characterizing said injury site from said second visit into said second objective findings record;
means for calculating a percent deficit for each measurement by comparing each measurement to said standard, and a percent improvement by comparing said first measurement taken on a first visit to said second measurement taken on said second visit to produce a plurality of calculated objective findings; and
means for generating a report that presents each of said measurements and each of said calculated objective findings in a graphical format and/or a tabular format.

11. The system of claim 10 wherein said claim record is further associated with a non-injured side record and the system further comprises:
means for selecting a standard and creating a third objective findings record that is associated with said first visit record and said non-injured side record;
means for inputting a first non-injured side measurement characterizing said non-injured side from said first visit into said third objective findings record;
means for creating a fourth objective findings record that is associated with said second visit record and said non-injured side record;
means for inputting a second non-injured side measurement characterizing said non-injured side from said second visit into said fourth objective findings record;
means for calculating a non-injured percent deficit for each non-injured side measurement by comparing each non-injured side measurement to said standard, and a percent improvement by comparing said first non-injured side measurement taken on a first visit to said second non-injured side measurement taken on said second visit to produce a second plurality of calculated objective findings.

12. A computer-implemented system for evaluating a soft-tissue injury claim, said system comprising:
means for inputting a claimant;
means for creating a claim and associating it with said claimant and with an injury site;
means for associating a first visit with said claim;
means for selecting a standard;
means for inputting a first measurement characterizing said injury site from said first visit;
means for associating a second visit with said claim;
means for inputting a second measurement characterizing said injury site from said second visit;
means for calculating a percent deficit for each measurement by comparing each measurement to said standard, and a percent improvement by comparing said first measurement taken on a first visit to said second measurement taken on said second visit to produce a plurality of calculated findings; and
means for generating a report that presents each of said measurements and each of said calculated findings in a graphical format and/or a tabular format.

13. The method of claim 12 wherein said claim is further associated with a non-injured side and the system further comprises:
means for inputting a first non-injured side measurement characterizing said non-injured side from said first visit;
means for inputting a second non-injured side measurement characterizing said non-injured side from said second visit;
means for calculating a non-injured percent deficit for each non-injured side measurement by comparing each non-injured side measurement to said standard, and a percent improvement by comparing said first non-injured side measurement taken on a first visit to said second non-injured side measurement taken on said second visit to produce a second plurality of calculated findings.

14. A computer-implemented system for evaluating a soft-tissue injury claim, said system comprising:
means for creating a claimant record;
means for creating a claim record and associating it with said claimant record, said claim record being associated with an injury site record;
means for inputting an injury site to said injury site record;
means for associating a first visit record with said claim record;
means for selecting a standard and creating a first objective findings record that is associated with said first visit record and said injury site record;
means for inputting a first measurement characterizing said injury site from said first visit into said first objective findings record;
means for associating a second visit record with said claim record;
means for creating a second objective findings record that is associated with said second visit record and said injury site record;
means for inputting a second measurement characterizing said injury site from said second visit into said second objective findings record;
means for calculating a percent deficit for each measurement by comparing each measurement to said standard, and a percent improvement by comparing said first measurement taken on a first visit to said second measurement taken on said second visit to produce a plurality of calculated objective findings; and
means for generating a report that presents each of said measurements and each of said calculated objective findings.

15. The system of claim 14 wherein said report comprises a bar graph having a bar that represents each measurement.

16. A computer-implemented system for evaluating a condition, said system comprising:
means for selecting a protocol that characterizes a severity of the condition, and identifying a standard result of performing said protocol on a patient that does not have said condition;
means for inputting a plurality of visit records, each visit record comprising a visit date, and a measurement of said severity obtained by having said patient perform said protocol;
means for calculating a percent deficit by comparing said measurement to said standard result, and a percent improvement by comparing one measurement taken on a first visit date to another measurement taken on a subsequent visit date to produce a plurality of objective findings; and
means for generating a report that presents each of said objective findings.

17. The system of claim 16 further comprising:
means for adding a finding and/or a recommendation to said report.

18. A computer-implemented system for evaluating a condition having a severity, said system comprising:
a computer having a memory and a monitor, said memory hosting a database;
said database having at least one claim record that is associated with a claimant record;
each claim record having an injury site record and a visit record, and optionally a report history record, a saved reports record, a carrier record, a provider record, an attorney record, an adjuster record, a private investigator record and/or a reviewer record;
each visit record having a date of examination field and being associated with at least one objective finding record, each objective finding record containing an objective finding comprising a range of motion measurement that characterizes the severity of the condition;
said monitor being operative to display a report for each injury site, said report containing a tabular or bar graph representation of each objective finding on each examination date and a comparison of each objective finding to a standard over time, said comparison comprising a percent improvement from a baseline objective finding and a percent deficit from said standard.

19. A computer-readable medium having computer-executable instructions for performing a method for evaluating the effects of treatment of an injury, the method comprising:
selecting a protocol that characterizes a severity of the injury, and identifying a standard result of performing said protocol on a patient that does not have the injury;
inputting a plurality of visit records, each visit record comprising a visit date, and a measurement of said severity obtained by having said patient perform said protocol;
calculating a percent deficit by comparing said measurement to said standard result, and a percent improvement by comparing one measurement taken on a first visit date to another measurement taken on a subsequent visit date to produce a plurality of objective findings; and
generating a report that presents all of said objective findings.

20. A computer-readable medium having computer-executable instructions for performing a method for evaluating the effects of treatment, the method comprising:
performing the steps of claim 1.

21. A computer-implemented method for evaluating an injury to a claimant, said method comprising:
selecting a claim from a claim grid, said claim having a date that the injury occurred, a protocol that characterizes a severity of the injury, and having a standard result of performing said protocol on a patient that does not have the injury;
inputting a plurality of visit records, each visit record comprising a visit date, and a measurement of said severity obtained by having said claimant perform said protocol;
calculating a percent deficit by comparing said measurement to said standard result, and a percent improvement by comparing one measurement taken on a first visit date to another measurement taken on a subsequent visit date to produce a plurality of objective findings; and
generating a report that presents a selected number of said objective findings.

22. The computer-implemented method of claim 21 wherein said report being selected from the group consisting of
an initial report,
a follow-up report,
an injury history report, and
a special comprehensive report.

23. The computer-implemented method of claim 22 wherein said initial report comprises: (1) a name and address of carrier and adjuster, (2) a report date, (3) a reviewer name and contact information, (4) a summary of information about said claim and the claimant, (5) a reviewer's findings, recommendations and additional information, (6) a summary of the initial findings measurements, (7) a summary of recent findings measurements, (8) a summary of the claimant's history of visits, (9) a history of special evaluations, hospitalizations, and special diagnostic procedures and (10) a history of private investigation reports.

24. The computer-implemented method of claim 22 wherein said follow-up report comprises: (1) a name and address of a carrier and an adjuster, (2) a report date, (3) a reviewer name and contact information, (4) a summary of information about said claim and the claimant, (5) a reviewer's findings and recommendations, (6) a summary of recent findings measurements, (7) a summary of the claimant's history of visits since a previous report was generated, (9) a history of special evaluations, hospitalizations, and special diagnostic procedures since said last report was generated and (10) a history of private investigation reports since said last report was generated.

25. The computer-implemented method of claim 22 wherein said injury history report comprises: (1) a name and address of a carrier and an adjuster, (2) a report date, (3) a reviewer name and contact information, (4) a summary of information about said claim and the claimant, (5) reviewer's findings and recommendations and (6) a summary of injuries information from any past claims or as reported in a history of previous injuries record associated with the claimant.

26. The computer-implemented method of claim 22 wherein said special comprehensive report includes: (1) a name and address of a carrier and an adjuster, (2) report date, (3) a reviewer name and contact information, (4) a summary of information about said claim and the claimant, (5) a reviewer's findings and recommendations, (6) a summary of recent findings measurements, (7) a summary of said claimant's history of visits, (8) a history of special evaluations, hospitalizations, and special diagnostic procedures, (9) a list of any additional injuries identified after an initial visit, (10) a history of previous injuries and previous claims, (11) a history of private investigation reports, (12) a list of accident facts entered into injury site records, (13) a list of any treatment notes from providers that were entered into visit records.

27. The computer-implemented method of claim 22 wherein said inputting step is carried out using a personal digital assistant.
